(19) United States
(12) Patent Application Publication
(10) Pub. No.: US 2026/0141909 A1
(43) Pub. Date: May 21, 2026

(54) AUDIO RESTORATION METHOD AND APPARATUS

(71) Applicant: Beijing Zitiao Network Technology Co., Ltd., Beijing (CN)

(72) Inventors: Xiaohuai LE, Beijing (CN); Zhuangqi Chen, Beijing (CN); Siyu Sun, Beijing (CN); Xianjun Xia, Sydney (AU); Chuanzeng Huang, Sydney (AU)

(21) Appl. No.: 19/383,486

(22) Filed: Nov. 7, 2025

(30) Foreign Application Priority Data
Nov. 15, 2024 (CN) 202411640257.3

(51) Int. Cl. G10L 21/02; G10L 25/78

(52) U.S. Cl. CPC G10L 21/02; G10L 25/78; G10L 2025/783

(57) ABSTRACT

Embodiments of this application provide an audio restoration method and apparatus, and relates to the technical field of audio restoration. The method includes: performing pop detection on audio to be restored to obtain a pop proportion of the audio to be restored; performing pop restoration on the audio to be restored to obtain first audio in a case where the pop proportion is greater than a first threshold; performing speech detection on the first audio to obtain a speech proportion of the first audio; converting, in a case where the speech proportion is greater than a second threshold, the first audio into a first time-frequency domain signal, segmenting the first time-frequency domain signal into a first number of sub-band signals with non-overlapping frequency bands according to a resolution of the first audio, respectively obtaining spectrum features of the first number of sub-band signals.

### CROSS-REFERENCE TO RELATED APPLICATION(S)

This application claims priority to Chinese Application No. 202411640257.3 filed Nov. 15, 2024, the disclosure of which is incorporated herein by reference in its entirety.

### FIELD

This application relates to the technical field of audio restoration, and in particular, to an audio restoration method and apparatus.

### BACKGROUND

For mixed audio obtained through real-time recording or audio mixing, there is often a need for audio restoration due to interference factors in an audio generation link that may affect audio quality, such as pops, reverberation, filtering effects, and coding-decoding impairments. The audio restoration technology aims to extract valid audio from the audio and repair audio quality damage caused by the above-mentioned interference factors.

### SUMMARY

In view of this, embodiments of this application provide an audio restoration method and apparatus, to solve the problems that current audio restoration technologies struggle to cope with complex and multi-dimensional audio restoration.

To implement the above-mentioned objective, the embodiments of this application provide the following technical solutions.

In a first aspect, an embodiment of this application provides an audio restoration method. The method includes:
performing pop detection on audio to be restored to obtain a pop proportion of the audio to be restored;
performing pop restoration on the audio to be restored to obtain first audio in a case where the pop proportion is greater than a first threshold;
performing speech detection on the first audio to obtain a speech proportion of the first audio;
converting, in a case where the speech proportion is greater than a second threshold, the first audio into a first time-frequency domain signal, segmenting the first time-frequency domain signal into a first number of sub-band signals with non-overlapping frequency bands according to a resolution of the first audio, respectively obtaining spectrum features of the first number of sub-band signals, and performing speech separation on the first audio according to the spectrum features of each sub-band signal to obtain second audio; and
performing audio quality restoration on the second audio to obtain a restoration result of the audio to be restored.

As an optional implementation of this embodiment of this application, performing the pop detection on the audio to be restored includes performing the pop detection on the audio to be restored based on a pop detection model. The pop detection model includes:
a first transformation module, configured to perform a short-time Fourier transform on the audio to be restored to obtain a second time-frequency domain signal;
a first feature extraction module, configured to perform feature extraction on the second time-frequency domain signal to obtain first features, where the first feature extraction module comprises a plurality of cascaded feature extraction units, and each feature extraction unit comprises a convolutional layer and a parametric rectified linear unit layer which are sequentially connected in series; and
a pop prediction module, configured to process the first features to obtain a probability of each audio frame in the audio to be restored being a pop, where the pop prediction module comprises a linear layer and an activation function layer which are sequentially connected in series.

As an optional implementation of this embodiment of this application, performing the speech detection on the first audio includes: performing the speech detection on the first audio based on a speech detection model. The speech detection model includes:
a second feature extraction module, configured to extract log-Mel features of the audio to be restored;
a first convolution module, configured to process the log-Mel features to obtain second features, where the first convolution module comprises a convolutional layer, a batch normalization layer, a context gating layer, a squeeze-and-excitation layer, and an average pooling layer which are sequentially connected in series;
an adaptive convolution module, configured to process the second features to obtain third features, where the adaptive convolution module comprises a plurality of cascaded adaptive convolution units, and each adaptive convolution unit comprises a frequency-adaptive convolutional block, a batch normalization layer, a context gating layer, a squeeze-and-excitation layer, and an average pooling layer which are sequentially connected in series;
a second convolution module, configured to process the third features to obtain fourth features, where the second convolution module comprises a convolutional layer, a batch normalization layer, a context gating layer, and an average pooling layer which are sequentially connected in series;
a bidirectional gated recurrent unit, configured to process the fourth features to obtain fifth features; and
a speech prediction module, configured to process the fifth features to obtain a probability of each audio frame in the audio to be restored, including a speech, where the speech prediction module comprises a linear layer and an activation function layer which are sequentially connected in series.

As an optional implementation of this embodiment of this application, the frequency-adaptive convolutional block includes:
a multi-dimensional attention block, used to obtain an input attention weight and an output attention weight based on input features of the frequency-adaptive convolutional block, where the multi-dimensional attention block includes a feature extraction structure, an input attention structure, and an output attention structure, the feature extraction structure comprises a time-domain average pooling layer, a convolutional layer, a batch normalization layer, and an activation function layer which are sequentially connected in series, and the input attention structure and the output attention structure are each composed of a convolutional layer and an activation function layer which are sequentially connected in sequence;
a first multiplier, used to calculate a product of the input features of the frequency-adaptive convolutional block and the input attention weight to obtain sixth features;
a two-dimensional convolutional layer, used to perform a convolution operation on the sixth features to obtain seventh features; and
a second multiplier, used to calculate a product of the seventh features and the output attention weight to obtain output features of the frequency-adaptive convolutional block.

As an optional implementation of this embodiment of this application, before performing the speech detection on the audio to be restored based on the speech detection model, the method further includes:
obtaining a first teacher model and a second teacher model, where the first teacher model has a larger number of parameters than the speech detection model, and the second teacher model is a model obtained by training a bidirectional encoder representation from audio transformers model; and
performing knowledge distillation on the speech detection model based on the first teacher model and the second teacher model.

As an optional implementation of this embodiment of this application, performing the knowledge distillation on the speech detection model based on the first teacher model and the second teacher model includes:
inputting first sample audio into the speech detection model, and obtaining a first speech separation result output by the speech detection model, and first intermediate features output by the second convolution module of the speech detection model;
inputting the first sample audio into the first teacher model, and obtaining a second speech separation result output by the first teacher model;
inputting the first sample audio into the second teacher model, and obtaining second intermediate features output by a target intermediate layer of the second teacher model, where the target intermediate layer is a layer structure in the second teacher model corresponding to the second convolution module;
calculating a binary cross-entropy loss between the first speech separation result and label information of the first sample audio to obtain a first loss value;
calculating a similarity loss between the first speech separation result and the second speech separation result to obtain a second loss value;
calculating a similarity loss between the first intermediate features and the second intermediate features to obtain a third loss value;
fusing the first loss value, the second loss value, and the third loss value to obtain a first fused loss value; and
adjusting parameters of the speech detection model based on the first fused loss value.

As an optional implementation of this embodiment of this application, performing the pop restoration on the audio to be restored to obtain the first audio includes: performing the pop restoration on the audio to be restored based on a pop restoration model to obtain the first audio. The pop restoration model includes:
a first encoding module, configured to process the audio to be restored to obtain eighth features, where the first encoding module includes L cascaded encoders, and each encoder comprises a convolutional layer, a batch normalization layer, and a parametric rectified linear unit layer, which are sequentially connected in series;
a third feature extraction module, configured to process the eighth features to obtain ninth features, where the third feature extraction module comprises a plurality of bidirectional long short-term memory networks which are connected in series; and
a first decoding module, configured to process the ninth features to obtain the first audio, where the first decoding module includes L cascaded decoders, each decoder comprises a concatenation layer, a convolutional layer, a batch normalization layer, a gated linear unit, and a transposed convolutional layer which are sequentially connected in series, the concatenation layer of the i-th decoder is used to concatenate output features of the (i−1)-th decoder and output features of the (L−i+1)-th encoder, L and i are positive integers, and i≤L.

As an optional implementation of this embodiment of this application, before performing the pop restoration on the audio to be restored based on the pop restoration model, the method further includes:
inputting the second sample audio into the pop restoration model and obtaining a pop restoration result of the second sample audio output by the pop restoration model;
calculating an L1 loss between the pop restoration result and label information of the second sample audio to obtain a first time-domain loss value;
calculating a mean squared error loss between the pop restoration result and the label information of the second sample audio at a plurality of resolutions to obtain a first frequency-domain loss value;
fusing the first time-domain loss value and the first frequency-domain loss value to obtain a second fused loss value; and
adjusting parameters of the pop restoration model based on the second fused loss value.

As an optional implementation of this embodiment of this application,
converting the first audio into the first time-frequency domain signal, segmenting the first time-frequency domain signal into the first number of sub-band signals with the non-overlapping frequency bands based on the resolution of the first audio, respectively obtaining the spectrum features of the sub-band signals, and performing the speech separation on the first audio based on the spectrum features of each sub-band signal to obtain the second audio includes: converting the first audio into a first time-frequency domain signal based on a speech separation model, segmenting the first time-frequency domain signal into a first number of sub-band signals with non-overlapping frequency bands based on a resolution of the first audio, respectively obtaining spectrum features of the sub-band signals, and performing speech separation on the first audio based on the spectrum features of each sub-band signal to obtain second audio; and the speech separation model includes:
a second transformation module, configured to perform the short-time Fourier transform on the first audio to obtain the first time-frequency domain signal;
a frequency band segmentation module, including a segmentation unit and a selection unit, where the segmentation unit is used to segment the first time-frequency domain signal into a second number of sub-band signals with non-overlapping frequency bands, the selection unit is used to determine an effective frequency band of the audio to be restored based on a resolution of the audio to be restored, determine a first number based on the effective frequency band, and select the first number of sub-band signals from the second number of sub-band signals to segment the first time-frequency domain signal into the first number of sub-band signals with non-overlapping frequency bands, and the second number is greater than or equal to the first number;
a frequency band sequence modeling module, configured to respectively process the first number of sub-band signals to obtain spectrum features of the first number of sub-band signals, where the frequency band sequence modeling module comprises a plurality of sequence modeling units connected in series, and each sequence modeling unit comprises two cascaded transformer layers;
a frequency band merging module, configured to merge the spectrum features of the first number of sub-band signals to obtain a spectral mask of the first audio; and
an output module, configured to calculate a product of the spectral mask and the first audio to obtain the second audio.

As an optional implementation of this embodiment of this application, before performing the speech separation on the first audio based on the speech separation model, the method further includes:
inputting third sample audio into the speech separation model and obtaining a speech separation result of the third sample audio output by the speech separation model;
calculating an L1 loss between the speech separation result and label information of the third sample audio to obtain a second time-domain loss value;
calculating a mean squared error loss between the speech separation result and the label information of the third sample audio at a plurality of resolutions to obtain a second frequency-domain loss value;
fusing the second time-domain loss value and the second frequency-domain loss value to obtain a third fused loss value; and
adjusting parameters of the speech separation model based on the third fused loss value.

As an optional implementation of this embodiment of this application, performing the audio quality restoration on the second audio to obtain the restoration result of the audio to be restored includes: performing audio quality restoration on the second audio based on an audio quality restoration model to obtain a restoration result of the audio to be restored. The audio quality restoration model includes:
a third transformation module, configured to perform the short-time Fourier transform on the second audio to obtain a third time-frequency domain signal;
a second encoding module, configured to process the third time-frequency domain signal to obtain tenth features, where the encoding module includes N cascaded encoders, and each encoder comprises a convolutional layer, a batch normalization layer, and a parametric rectified linear unit layer which are sequentially connected in series;
a fourth feature extraction module, configured to process the tenth features to obtain eleventh features, where the fourth feature extraction module comprises a plurality of deep bidirectional long short-term memory networks which are connected in series;
a second decoding module, configured to process the eleventh features to obtain twelfth features, where the decoding module includes N cascaded decoders, each decoder comprises a concatenation layer, a convolutional layer, a batch normalization layer, a gated linear unit, and a transposed convolutional layer which are sequentially connected in series, the concatenation layer of the j-th decoder is used to concatenate output features of the (j−1)-th decoder and output features of the (N−j+1)-th encoder, N and j are positive integers, and j≤N; and
a fourth transformation module, configured to perform an inverse short-time Fourier transform on the twelfth features to obtain a restoration result of the audio to be restored.

As an optional implementation of this embodiment of this application, before performing the audio quality restoration on the second audio based on the audio quality restoration model, the method further includes:
inputting fourth sample audio into the audio quality restoration model and obtaining an audio quality restoration result of the fourth sample audio output by the audio quality restoration model;
inputting the audio quality restoration result into a frequency-domain discriminator and obtaining a first probability value output by the frequency-domain discriminator and a first frequency-domain hidden feature output by a hidden layer of the frequency-domain discriminator, where the first probability value is a probability predicted by the frequency-domain discriminator that the audio quality restoration result is label information corresponding to the fourth sample audio;
inputting the audio quality restoration result into a sub-band discriminator and obtaining a second probability value output by the sub-band discriminator and a second sub-band hidden feature of a hidden layer of the sub-band discriminator, where the second probability value is a probability predicted by the sub-band discriminator that the audio quality restoration result is the label information corresponding to the fourth sample audio;
calculating a mean squared error loss between the audio quality restoration result and the label information of the fourth sample audio at a plurality of resolutions to obtain a third frequency-domain loss value;
obtaining an adversarial generation loss value based on the first probability value, the second probability value, the first frequency-domain hidden feature, a second frequency-domain hidden feature, the second sub-band hidden feature, and a second sub-band hidden feature, where the second frequency-domain hidden feature and the second sub-band hidden feature are an output of the hidden layer of the frequency-domain discriminator and an output of the hidden layer of the sub-band discriminator respectively when the label information corresponding to the fourth sample audio is used as an input;
fusing the third frequency-domain loss value and the adversarial generation loss value to obtain a fourth fused loss value; and
adjusting parameters of the audio quality restoration model based on the fourth fused loss value.

As an optional implementation of this embodiment of this application, the method further includes:
performing audio quality restoration on the first audio to obtain a restoration result of the audio to be restored in a case where the speech proportion is less than or equal to the second threshold.

As an optional implementation of this embodiment of this application, the method further includes:
performing speech detection on the audio to be restored to obtain a speech proportion of the audio to be restored in a case where the pop proportion is less than or equal to the first threshold;
converting, in a case where the speech proportion is greater than the second threshold, the audio to be restored into a second time-frequency domain signal, segmenting the second time-frequency domain signal into a first number of sub-band signals with non-overlapping frequency bands based on a resolution of the audio to be restored, respectively obtaining spectrum features of the first number of sub-band signals, and performing speech separation on the audio to be restored based on the spectrum features of each sub-band signal to obtain third audio; and
performing audio quality restoration on the third audio to obtain a restoration result of the audio to be restored.

As an optional implementation of this embodiment of this application, the method further includes:
performing audio quality restoration on the audio to be restored to obtain a restoration result of the audio to be restored in a case where the pop proportion is less than or equal to the first threshold and the speech proportion is less than or equal to the second threshold.

In a second aspect, an embodiment of this application provides an audio restoration apparatus. The apparatus includes:
a pop detection module, configured to perform pop detection on audio to be restored to obtain a pop proportion of the audio to be restored;
a pop restoration module, configured to perform pop restoration on the audio to be restored to obtain first audio in a case where the pop proportion is greater than a first threshold;
a speech detection module, configured to perform speech detection on the first audio to obtain a speech proportion of the first audio;
a speech separation module, configured to convert, in a case where the speech proportion is greater than a second threshold, the first audio into a first time-frequency domain signal, segment the first time-frequency domain signal into a first number of sub-band signals with non-overlapping frequency bands based on a resolution of the first audio, respectively obtain spectrum features of the first number of sub-band signals, and perform speech separation on the first audio based on the spectrum features of each sub-band signal to obtain second audio; and
an audio quality restoration module, configured to perform audio quality restoration on the second audio to obtain a restoration result of the audio to be restored.

As an optional implementation of this embodiment of this application, the pop detection module is specifically configured to perform pop detection on the audio to be restored based on a pop detection model. The pop detection model includes:
a first transformation module, configured to perform a short-time Fourier transform on the audio to be restored to obtain a second time-frequency domain signal;
a first feature extraction module, configured to perform feature extraction on the second time-frequency domain signal to obtain first features, where the first feature extraction module comprises a plurality of cascaded feature extraction units, and each feature extraction unit comprises a convolutional layer and a parametric rectified linear unit layer which are sequentially connected in series; and
a pop prediction module, configured to process the first features to obtain a probability of each audio frame in the audio to be restored being a pop, where the pop prediction module comprises a linear layer and an activation function layer which are sequentially connected in series.

As an optional implementation of this embodiment of this application, the speech detection module is specifically configured to perform speech detection on the audio to be restored based on a speech detection model. The speech detection model includes:
a second feature extraction module, configured to extract log-Mel features of the audio to be restored;
a first convolution module, configured to process the log-Mel features to obtain second features, where the first convolution module comprises a convolutional layer, a batch normalization layer, a context gating layer, a squeeze-and-excitation layer, and an average pooling layer which are sequentially connected in series;
an adaptive convolution module, configured to process the second features to obtain third features, where the adaptive convolution module comprises a plurality of cascaded adaptive convolution units, and each adaptive convolution unit comprises a frequency-adaptive convolutional block, a batch normalization layer, a context gating layer, a squeeze-and-excitation layer, and an average pooling layer which are sequentially connected in series;
a second convolution module, configured to process the third features to obtain fourth features, where the second convolution module comprises a convolutional layer, a batch normalization layer, a context gating layer, and an average pooling layer which are sequentially connected in series;
a bidirectional gated recurrent unit, configured to process the fourth features to obtain fifth features; and
a speech prediction module, configured to process the fifth features to obtain a probability of each audio frame in the audio to be restored including a speech, where the speech prediction module comprises a linear layer and an activation function layer which are sequentially connected in series.

As an optional implementation of this embodiment of this application, the frequency-adaptive convolutional block includes:
a multi-dimensional attention block, used to obtain an input attention weight and an output attention weight based on input features of the frequency-adaptive convolutional block, where the multi-dimensional attention block includes a feature extraction structure, an input attention structure, and an output attention structure, the feature extraction structure comprises a time-domain average pooling layer, a convolutional layer, a batch normalization layer, and an activation function layer which are sequentially connected in series, and the input attention structure and the output attention structure are each composed of a convolutional layer and an activation function layer which are sequentially connected in sequence;
a first multiplier, used to calculate a product of the input features of the frequency-adaptive convolutional block and the input attention weight to obtain sixth features;
a two-dimensional convolutional layer, used to perform a convolution operation on the sixth features to obtain seventh features; and
a second multiplier, used to calculate a product of the seventh features and the output attention weight to obtain output features of the frequency-adaptive convolutional block.

As an optional implementation of this embodiment of this application, the speech detection module is further configured to obtain a first teacher model and a second teacher model before performing the speech detection on the audio to be restored based on the speech detection model, where the first teacher model has a larger number of parameters than the speech detection model, and the second teacher model is a model obtained by training a bidirectional encoder representation from audio transformers model; and perform knowledge distillation on the speech detection model based on the first teacher model and the second teacher model.

As an optional implementation of this embodiment of this application, the speech detection module is specifically configured to input first sample audio into the speech detection model, and obtain a first speech separation result output by the speech detection model, and first intermediate features output by the second convolution module of the speech detection model; input the first sample audio into the first teacher model, and obtain a second speech separation result output by the first teacher model; input the first sample audio into the second teacher model, and obtain second intermediate features output by a target intermediate layer of the second teacher model, where the target intermediate layer is a layer structure in the second teacher model corresponding to the second convolution module; calculate a binary cross-entropy loss between the first speech separation result and label information of the first sample audio to obtain a first loss value; calculate a similarity loss between the first speech separation result and the second speech separation result to obtain a second loss value; calculate a similarity loss between the first intermediate features and the second intermediate features to obtain a third loss value; fuse the first loss value, the second loss value, and the third loss value to obtain a first fused loss value; and adjust parameters of the speech detection model based on the first fused loss value.

As an optional implementation of this embodiment of this application, the pop restoration module is specifically configured to perform, based on a pop restoration model, pop restoration on the audio to be restored to obtain first audio. The pop restoration model includes:
a first encoding module, configured to process the audio to be restored to obtain eighth features, where the first encoding module includes L cascaded encoders, and each encoder comprises a convolutional layer, a batch normalization layer, and a parametric rectified linear unit layer which are sequentially connected in series;
a third feature extraction module, configured to process the eighth features to obtain ninth features, where the third feature extraction module comprises a plurality of bidirectional long short-term memory networks which are connected in series; and
a first decoding module, configured to process the ninth features to obtain the first audio, where the first decoding module includes L cascaded decoders, each decoder comprises a concatenation layer, a convolutional layer, a batch normalization layer, a gated linear unit, and a transposed convolutional layer which are sequentially connected in series, the concatenation layer of the i-th decoder is used to concatenate output features of the (i−1)-th decoder and output features of the (L−i+1)-th encoder, L and i are positive integers, and i≤L.

As an optional implementation of this embodiment of this application, the pop restoration model is further configured to input second sample audio into the pop restoration model and obtain a pop restoration result of the second sample audio output by the pop restoration model before performing the pop restoration on the audio to be restored based on the pop restoration model; calculate an L1 loss between the pop restoration result and label information of the second sample audio to obtain a first time-domain loss value; calculate a mean squared error loss between the pop restoration result and the label information of the second sample audio at a plurality of resolutions to obtain a first frequency-domain loss value; fuse the first time-domain loss value and the first frequency-domain loss value to obtain a second fused loss value; and adjust parameters of the pop restoration model based on the second fused loss value.

As an optional implementation of this embodiment of this application, the speech separation module is specifically configured to convert the first audio into a first time-frequency domain signal based on the speech separation model, segment the first time-frequency domain signal into a first number of sub-band signals with non-overlapping frequency bands based on a resolution of the first audio, respectively obtain spectrum features of the sub-band signals, and perform speech separation on the first audio based on the spectrum features of each sub-band signal to obtain second audio. The speech separation model includes:
a second transformation module, configured to perform the short-time Fourier transform on the first audio to obtain the first time-frequency domain signal;
a frequency band segmentation module, including a segmentation unit and a selection unit, where the segmentation unit is used to segment the first time-frequency domain signal into a second number of sub-band signals with non-overlapping frequency bands, the selection unit is used to determine an effective frequency band of the audio to be restored based on a resolution of the audio to be restored, determine a first number based on the effective frequency band, and select the first number of sub-band signals from the second number of sub-band signals to segment the first time-frequency domain signal into the first number of sub-band signals with non-overlapping frequency bands, and the second number is greater than or equal to the first number;
a frequency band sequence modeling module, configured to respectively process the first number of sub-band signals to obtain spectrum features of the first number of sub-band signals, where the frequency band sequence modeling module comprises a plurality of sequence modeling units connected in series, and each sequence modeling unit comprises two cascaded transformer layers;
a frequency band merging module, configured to merge the spectrum features of the first number of sub-band signals to obtain a spectral mask of the first audio; and
an output module, configured to calculate a product of the spectral mask and the first audio to obtain the second audio.

As an optional implementation of this embodiment of this application, the speech separation module is further configured to input third sample audio into the speech separation model and obtain a speech separation result of the third sample audio output by the speech separation model before performing the speech separation on the first audio based on the speech separation model; calculate an L1 loss between the speech separation result and label information of the third sample audio to obtain a second time-domain loss value; calculate a mean squared error loss between the speech separation result and the label information of the third sample audio at a plurality of resolutions to obtain a second frequency-domain loss value; fuse the second time-domain loss value and the second frequency-domain loss value to obtain a third fused loss value; and adjust parameters of the speech separation model based on the third fused loss value.

As an optional implementation of this embodiment of this application, the audio quality restoration module is specifically configured to perform audio quality restoration on the second audio based on an audio quality restoration model to obtain a restoration result of the audio to be restored. The audio quality restoration model includes:
a third transformation module, configured to perform the short-time Fourier transform on the second audio to obtain a third time-frequency domain signal;
a second encoding module, configured to process the third time-frequency domain signal to obtain tenth features, where the encoding module includes N cascaded encoders, and each encoder comprises a convolutional layer, a batch normalization layer, and a parametric rectified linear unit layer which are sequentially connected in series;
a fourth feature extraction module, configured to process the tenth features to obtain eleventh features, where the fourth feature extraction module comprises a plurality of deep bidirectional long short-term memory networks which are connected in series;
a second decoding module, configured to process the eleventh features to obtain twelfth features, where the decoding module includes N cascaded decoders, each decoder comprises a concatenation layer, a convolutional layer, a batch normalization layer, a gated linear unit, and a transposed convolutional layer which are sequentially connected in series, the concatenation layer of the j-th decoder is used to concatenate output features of the (j−1)-th decoder and output features of the (N−j+1)-th encoder, N and j are positive integers, and j≤N; and
a fourth transformation module, configured to perform an inverse short-time Fourier transform on the twelfth features to obtain a restoration result of the audio to be restored.

As an optional implementation of this embodiment of this application, the audio quality restoration module is further configured to input fourth sample audio into the audio quality restoration model and obtain an audio quality restoration result of the fourth sample audio output by the audio quality restoration model before performing the audio quality restoration on the second audio based on the audio quality restoration model: input the audio quality restoration result into a frequency-domain discriminator and obtain a first probability value output by the frequency-domain discriminator and a first frequency-domain hidden feature output by a hidden layer of the frequency-domain discriminator, where the first probability value is a probability predicted by the frequency-domain discriminator that the audio quality restoration result is label information corresponding to the fourth sample audio; input the audio quality restoration result into a sub-band discriminator and obtain a second probability value output by the sub-band discriminator and a second sub-band hidden feature of the hidden layer of the sub-band discriminator, where the second probability value is a probability predicted by the sub-band discriminator that the audio quality restoration result is the label information corresponding to the fourth sample audio; calculate a mean squared error loss between the audio quality restoration result and the label information of the fourth sample audio at a plurality of resolutions to obtain a third frequency-domain loss value; obtain an adversarial generation loss value based on the first probability value, the second probability value, the first frequency-domain hidden feature, a second frequency-domain hidden feature, the second sub-band hidden feature, and a second sub-band hidden feature, where the second frequency-domain hidden feature and the second sub-band hidden feature are an output of the hidden layer of the frequency-domain discriminator and an output of the hidden layer of the sub-band discriminator respectively when the label information corresponding to the fourth sample audio is used as an input; fuse the third frequency-domain loss value and the adversarial generation loss value to obtain a fourth fused loss value; and adjust parameters of the audio quality restoration model based on the fourth fused loss value.

As an optional implementation of this embodiment of this application,
the audio quality restoration module is further configured to perform audio quality restoration on the first audio to obtain a restoration result of the audio to be restored in a case where the speech proportion is less than or equal to the second threshold.

As an optional implementation of this embodiment of this application,
the speech detection module is further configured to perform speech detection on the audio to be restored to obtain a speech proportion of the audio to be restored in a case where the pop proportion is less than or equal to the first threshold;
the speech separation module is further configured to convert, in a case where the speech proportion is greater than the second threshold, the audio to be restored into a second time-frequency domain signal, segment the second time-frequency domain signal into a first number of sub-band signals with non-overlapping frequency bands based on a resolution of the audio to be restored, respectively obtain spectrum features of the first number of sub-band signals, and perform speech separation on the audio to be restored based on the spectrum features of each sub-band signal to obtain third audio; and
the audio quality restoration module is further configured to perform audio quality restoration on the third audio to obtain a restoration result of the audio to be restored.

As an optional implementation of this embodiment of this application,
the audio quality restoration module is further configured to perform audio quality restoration on the audio to be restored to obtain a restoration result of the audio to be restored in a case where the speech proportion is less than or equal to the second threshold.

The audio quality restoration module is further configured to perform audio quality restoration on the audio to be restored when it is determined that no pop restoration or speech separation is to be performed on the audio to be restored, so as to obtain a restoration result of the audio to be restored.

In a third aspect, an embodiment of this application provides an electronic device, including a memory and a processor. The memory is configured to store a computer program, and the processor is configured to perform the computer program to cause the electronic device to implement the audio restoration method based on any of the above-mentioned implementations.

In a fourth aspect, an embodiment of this application provides a computer-readable storage medium. A computer program, when executed by a computing device, causes the computing device to implement the audio restoration method according to any of the above-mentioned implementations.

In a fifth aspect, an embodiment of this application provides a computer program product. The computer program product, when running on a computer, causes a computer to implement the audio restoration method according to any of the above-mentioned implementations.

### BRIEF DESCRIPTION OF THE DRAWINGS

The accompanying drawings herein are incorporated into the specification to form a part of the specification, illustrate embodiments conforming to this application, and are used to explain the principle of this application together with the specification.

In order to more clearly illustrate the technical solutions in the embodiments of this application or in the related art, the accompanying drawings called for describing the embodiments or the related art will be briefly described below. Apparently, those of ordinary skill in the art may still derive other accompanying drawings from these accompanying drawings without creative efforts.

FIG. 1 is a first step flowchart of an audio restoration method according to an embodiment of this application;

FIG. 2 is a first schematic structural diagram of an audio restoration system according to an embodiment of this application;

FIG. 3 is a second step flowchart of an audio restoration method according to an embodiment of this application;

FIG. 4 is a schematic structural diagram of a pop detection model according to an embodiment of this application;

FIG. 5 is a schematic structural diagram of a speech detection model according to an embodiment of this application;

FIG. 6 is a schematic structural diagram of an adaptive convolutional block according to an embodiment of this application;

FIG. 7 is a schematic structural diagram of a pop restoration model according to an embodiment of this application;

FIG. 8 is a schematic structural diagram of a speech separation model according to an embodiment of this application;

FIG. 9 is a schematic structural diagram of an audio quality restoration model according to an embodiment of this application;

FIG. 10 is a third step flowchart of an audio restoration method according to an embodiment of this application;

FIG. 11 is a second schematic structural diagram of an audio restoration system according to an embodiment of this application;

FIG. 12 is a fourth step flowchart of an audio restoration method according to an embodiment of this application;

FIG. 13 is a third schematic structural diagram of an audio restoration system according to an embodiment of this application;

FIG. 14 is a fifth step flowchart of an audio restoration method according to an embodiment of this application;

FIG. 15 is a fourth schematic structural diagram of an audio restoration system according to an embodiment of this application;

FIG. 16 is a schematic structural diagram of an audio restoration apparatus according to an embodiment of this application; and

FIG. 17 is a schematic diagram of a hardware structure of an electronic device according to an embodiment of this application.

### DETAILED DESCRIPTION OF EMBODIMENTS

For a clearer understanding of the above-mentioned objectives, features, and advantages of this application, the solutions of this application will be further described below. It should be noted that embodiments in this application and features in the embodiments may be mutually combined without conflicts.

Many specific details are elaborated in the following description to facilitate a full understanding of this application, but this application may also be implemented in methods different from those described herein. Apparently, the embodiments in the specification are only a part rather all of the embodiments of this application.

In embodiments of this application, terms such as “exemplarily” and “for example” are used for exampling, illustration, or explanation. Any embodiment or design scheme described as “exemplary” or “for example” in the embodiments of this application should not be interpreted as being more preferable or advantageous over other embodiments or design schemes. Exactly, the use of terms like “exemplary” or “for example” is intended to present relevant concepts in a specific manner. Additionally, in the descriptions of the embodiments of this application, unless otherwise specified, “a plurality of” means two or more.

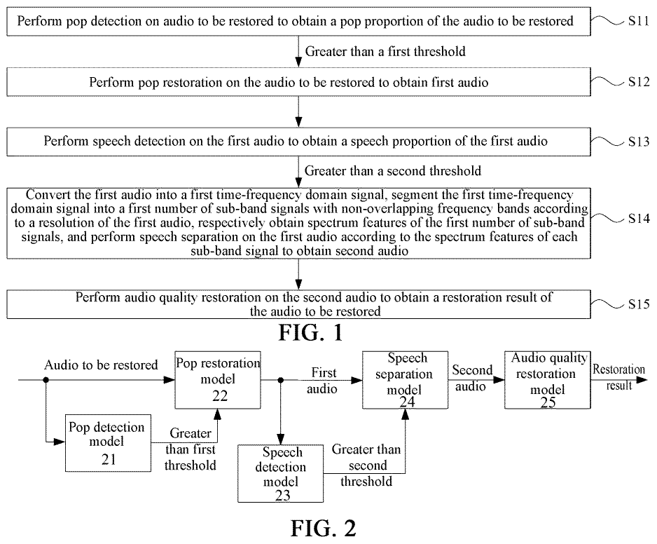

An embodiment of this application provides an audio restoration method. An execution entity of the audio restoration method may be an electronic device such as a mobile phone, a personal computer, a palmtop computer, and an in-vehicle device, or an audio restoration apparatus integrated into the electronic device. Referring to FIG. 1, the audio restoration method includes the following steps S11 to S15.

S11: A pop detection is performed on audio to be restored to obtain a pop proportion of the audio to be restored.

In some embodiments, the pop proportion is a ratio of a duration of pops in the audio to be restored to a total duration of the audio to be restored.

In some embodiments, the pop proportion is a ratio of the number of pop audio frames in the audio to be restored to a total number of audio frames in the audio to be restored.

Pops refer to sudden, very brief but highly intense abnormal sounds in an audio signal, and the sounds are often represented by sharp and piercing noises that abruptly appear during normal audio playback. The pops may severely interfere with a normal auditory feeling of the audio.

In some embodiments, the audio restoration method is implemented based on an audio restoration system. Referring to FIG. 2, the audio restoration system includes a pop detection model 21. The pop detection model 21 is used to perform pop detection on audio to be restored to obtain a pop proportion of the audio to be restored.

If the pop proportion obtained in step S11 above is greater than a first threshold, the following step S12 is performed:

S12: A pop restoration is performed on the audio to be restored to obtain first audio.

In some embodiments, the audio restoration method is implemented based on the audio restoration system. Referring to FIG. 2, the audio restoration system further includes: a pop restoration model 22. The pop restoration model 22 is used to perform pop restoration on the audio to be restored to obtain first audio.

S13: A speech detection is performed on the first audio to obtain a speech proportion of the first audio.

In some embodiments, the speech proportion is a ratio of a duration of a speech in the first audio to a total duration of the first audio.

In some other embodiments, the speech proportion is a ratio of the number of audio frames of the speech in the first audio to a total number of audio frames in the first audio.

It should be noted that since the first audio is audio obtained by performing the pop restoration on the audio to be restored, and the pop restoration does not affect the speech proportion in the audio to be restored, the speech proportion obtained by performing the speech detection on the first audio is the same as that obtained by performing the speech detection on audio frames to be restored. Therefore, in some embodiments, the speech detection may also be directly performed on the audio to be restored to obtain the speech proportion.

In some embodiments, the audio restoration method is implemented based on the audio restoration system. Referring to FIG. 2, the audio restoration system further includes: a speech detection model 23. The speech detection model 23 is used to perform speech detection on a first speech to obtain a speech proportion of the first audio.

If the speech proportion obtained in step S13 above is greater than a second threshold, the following step S14 is performed:

S14: The first audio is converted into a first time-frequency domain signal, segment the first time-frequency domain signal into a first number of sub-band signals with non-overlapping frequency bands according to a resolution of the first audio, respectively obtain spectrum features of the first number of sub-band signals, and speech separation is performed on the first audio according to the spectrum features of each sub-band signal to obtain second audio.

In some embodiments, converting the first audio into the first time-frequency domain signal includes: performing a short-time Fourier transform (STFT) on the first audio to convert the first audio into the first time-frequency domain signal.

The short-time Fourier transform is a signal processing technology that performs windowing on a signal. When the short-time Fourier transform is performed on an audio signal to be separated, a suitable window function is first set for the audio signal to be separated. The length of the window function determines a sampling rate for the audio signal to be separated. Then, the window function slides along a time axis, and the Fourier transform is performed on the audio signal to be separated within each window, thereby obtaining spectra of the audio signal to be separated at different time segments (determined by the window function), and thus converting the audio signal to be separated from a time domain signal to the time-frequency domain signal.

In some embodiments, segmenting the first time-frequency domain signal into the first number of sub-band signals with the non-overlapping frequency bands according to the resolution of the first audio includes: obtaining an effective bandwidth of the first audio according to the resolution of the first audio and a preset correspondence relationship, and calculating a ratio of the effective bandwidth of the first audio to a frequency band interval to obtain the first number. The preset correspondence relationship includes an effective bandwidth corresponding to each resolution.

In some embodiments, respectively obtaining the spectrum features of the first number of sub-band signals includes: respectively performing feature extraction on the plurality of sub-band signals to obtain sub-band features of the sub-band signals, stacking the sub-band features of the sub-band signals to obtain stacked features, and obtaining the spectrum features of the first number of sub-band signals according to inter-band and temporal dependencies of the sub-band features in the stacked features.

In some embodiments, performing the speech separation on the first audio according to the spectrum features of each sub-band signal to obtain the second audio includes: obtaining a speech mask for the first audio according to the spectrum features of each sub-band signal and calculating a product of the speech mask and the first audio to obtain the second audio.

In some embodiments, the audio restoration method is implemented based on the audio restoration system. Referring to FIG. 2, the audio restoration system further includes a speech separation model 24. The speech separation model 24 is used to perform speech separation on the first audio to obtain second audio.

S15: A audio quality restoration is performed on the second audio to obtain a restoration result of the audio to be restored.

In some embodiments, the audio restoration method is implemented based on the audio restoration system. Referring to FIG. 2, the audio restoration system further includes: an audio quality restoration model 25. The audio quality restoration model 25 is used to perform audio quality restoration on the second audio to obtain a restoration result of the audio to be restored.

In some embodiments, the pop detection model 21, the speech detection model 22, the pop restoration model 23, the speech separation model 24, and the audio quality restoration model 25 may be trained independently first. Then, the pop detection model 21, the speech detection model 22, the pop restoration model 23, the speech separation model 24, and the audio quality restoration model 25 which are trained are combined to obtain the audio restoration system, and then the audio restoration system is trained.

According to the audio restoration method provided in this embodiment of this application, when the audio to be restored is restored, the pop detection is first performed on the audio to be restored to obtain the pop proportion of the audio to be restored. In a case where the pop proportion is greater than the first threshold, the speech detection is performed on the first audio to obtain the speech proportion of the first audio. In a case where the speech proportion is greater than the second threshold, the first audio is converted into the first time-frequency domain signal. The first time-frequency domain signal is segmented into the first number of sub-band signals with the non-overlapping frequency bands according to the resolution of the first audio, and the spectrum features of the first number of sub-band signals are obtained respectively. The speech separation is performed on the first audio according to the spectrum features of the sub-band signals to obtain the second audio. Then, the audio quality restoration is performed on the second audio to obtain the restoration result of the audio to be restored. On one hand, since the audio restoration method provided in this embodiment of this application may determine whether to perform the pop restoration according to the pop proportion, whether to perform the speech separation according to the speech proportion, and then determine a subsequent speech restoration solution according to whether to perform the pop restoration and whether to perform the speech separation, the audio restoration method provided in this embodiment of this application may solve the problem that the audio restoration technology can only restore the audio quality damage caused by a certain type of interference factor. On the other hand, since during the speech separation, this embodiment of this application may determine the number of the segmented sub-band signals according to the resolution and subsequently obtain the speech separation result according to the segmented sub-band signals, the audio restoration method provided in this embodiment of this application can solve the problem of being limited to restoring audio at a specific resolution. In summary; this embodiment of this application may solve the problem that the audio restoration technologies struggle to cope with complex and multi-dimensional audio restoration.

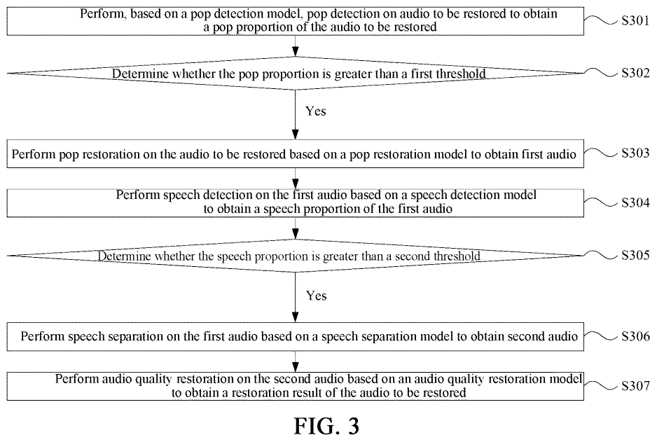

As an extension and refinement of the above-mentioned embodiments, an embodiment of this application further provides another audio restoration method. Referring to FIG. 3, the audio restoration method includes the following steps:

S301: Based on a pop detection model, pop detection is performed on audio to be restored to obtain a pop proportion of the audio to be restored.

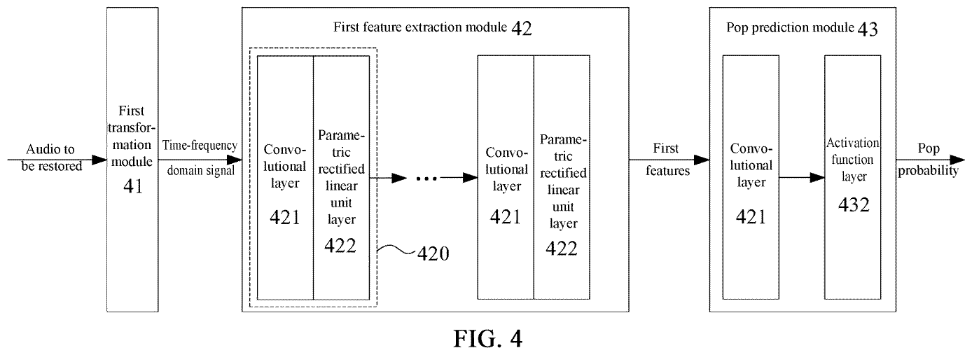

Referring to FIG. 4, the pop detection model includes: a first transformation module 41, a first feature extraction module 42, and a pop prediction module 43.

The first transformation module 41 is configured to perform a short-time Fourier transform on the audio to be restored to obtain a second time-frequency domain signal.

In some embodiments, a frame length for the short-time Fourier transform performed by the first transformation module 41 is 2048, with a frame shift of 512 and a Hanning window function.

The first feature extraction module 42 is configured to perform feature extraction on the second time-frequency domain signal to obtain first features. The first feature extraction module 42 comprises a plurality of cascaded feature extraction units 420, and each feature extraction unit 420 comprises a convolutional layer 421 and a parametric rectified linear unit (PRELU) layer 422 sequentially connected in series.

In some embodiments, the first feature extraction module 42 comprises seven layers of cascaded feature extraction units 420. The convolutional layers 421 of the seven layers of feature extraction units 420 are all two-dimensional convolutional layers, convolution kernel sizes are sequentially 3*5, 5*3, 5*3, 5*3, 5*3, 5*3, and 5*3, convolutional strides are sequentially (1, 1), (1, 1), (1, 4), (1, 4), (1, 4), (1, 4), and (1, 2), and the number of output channels is sequentially 16, 32, 64, 128, 128, 256, and 256.

The pop prediction module 43 is configured to process the first features to obtain a probability of each audio frame in the audio to be restored being a pop. The pop prediction module 43 comprises a linear layer 431 and an activation function layer 432 which are sequentially connected in series.

In some embodiments, an activation function used in the activation function layer 432 is a Sigmoid function.

In some embodiments, before performing, based on the pop detection model, pop detection on the audio to be restored, the method further includes: training the pop detection model.

In some embodiments, training the pop detection model includes:
inputting sample data into the pop detection model and obtaining a pop detection result of the sample data output by the pop detection model;
calculating a loss value according to the pop detection result and label information corresponding to the sample data; and
adjusting model parameters of the pop detection model according to the loss value.

For example, the audio to be restored includes1000 audio frames and the pop detection model predicts that the probability of 150 of the 1000 audio frames being pops is greater than a preset threshold; the pop proportion of the audio to be restored may be determined to be 150/1000=3/20.

In some embodiments, the sample data for training the pop detection model may be generated based on the following steps:
obtaining a target audio signal that does not contain pops, determining whether an absolute value of an amplitude of each audio frame in the target audio signal is greater than a clipping threshold, setting the amplitudes of the audio frames with the absolute values of the amplitudes greater than the clipping threshold to the clipping threshold, and setting signs of the amplitudes of the audio frames with the absolute values of the amplitudes greater than the clipping threshold to signs of the amplitudes of the audio frames with the absolute values of the amplitudes greater than the clipping threshold to obtain the sample data for training the pop detection model.

That is, the target audio signal is represented by x(t), the sample data for training the pop detection model is represented by y(t), and a process of generating the sample data for training the pop detection model may be represented by the following calculation formula (1):

$$y ( t ) = \{ \begin{matrix}x ( t ) & - {δ}_{m} < x ( t ) < {δ}_{m} \\ sign ( x ( t ) ) & {δ}_{m} \vert x ( t ) \vert \geq {δ}_{m}\end{matrix} \qquad ( 1 )$$

δₘ denotes the clipping threshold, and sign(x(t)) is a sign of x(t).

S302: Whether the pop proportion is determined greater than a first threshold.

In some embodiments, the first threshold may be 0. That is, if it is detected that the audio to be restored includes audio frames that are pops, it is determined to perform pop restoration on the audio to be restored.

In some embodiments, the first threshold may be 5%.

If the pop proportion is greater than the first threshold in step S302 above, the following step S303 is performed:

S303: A pop restoration is performed on the audio to be restored based on a pop restoration model to obtain first audio.

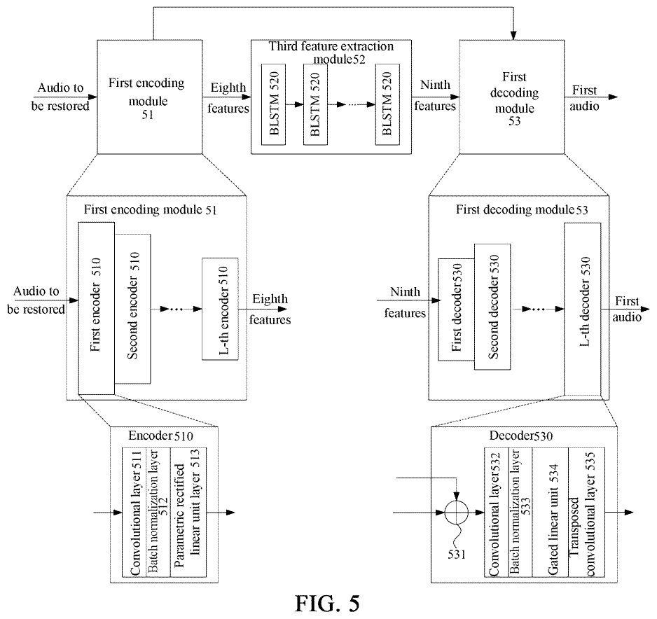

In some embodiments, referring to FIG. 5, the pop restoration model includes: a first encoding module 51, a third feature extraction module 52, and a first decoding module 53.

The first encoding module 51 is configured to process the audio to be restored to obtain eighth features. The first encoding module 51 includes L cascaded encoders 510, and each encoder 510 comprises a convolutional layer 511, a batch normalization layer 512, and a parametric rectified linear unit layer 513 which are sequentially connected in series.

In some embodiments, L=6. That is, the first encoding module includes 6 cascaded encoders.

In some embodiments, the convolutional layers 511 of the six encoders 510 are all one-dimensional convolutional layers, convolution kernel sizes are sequentially 8, 8, 8, 4, 4, and 4, convolutional strides are sequentially 4, 4, 4, 2, 2, and 2, and the number of output channels is sequentially 64, 128, 256, 512, 1024, and 1024.

The third feature extraction module 52 is configured to process the eighth features to obtain the ninth features. The third feature extraction module comprises a plurality of bidirectional long short-term memory (BLSTM) networks 520 which are connected in series.

In some embodiments, the third feature extraction module 52 comprises three bidirectional long short-term memory networks which are connected in series.

The first decoding module 53 is configured to process the ninth features to obtain the first audio. The first decoding module includes L cascaded decoders 530. Each decoder 530 comprises a concatenation layer 531, a convolutional layer 532, a batch normalization layer 533, a gated linear unit 534, and a transposed convolutional layer 535 which are sequentially connected in series. The concatenation layer of the i-th decoder is used to concatenate output features of the (i−1)-th decoder and output features of the (L−i+1)-th encoder, where L and i are positive integers and i≤L.

In some embodiments, L=6. That is, the first decoding module includes 6 cascaded decoders.

In some embodiments, the convolutional layers 532 of the six decoders 530 are all one-dimensional convolutional layers, convolution kernel sizes are sequentially 4, 4, 4, 8, 8, and 8, convolutional strides are sequentially 2, 2, 2, 4, 4, and 4, and the number of output channels is sequentially 1024, 1024, 512, 256, 128, and 64.

In some embodiments, before performing the pop restoration on the audio to be restored based on the pop restoration model, the pop restoration model is trained. An implementation for training the pop restoration model may include the following steps a to e:

Step a: Second sample audio is input into the pop restoration model and a pop restoration result of the second sample audio output by the pop restoration model is obtained.

Step b: An L1 loss between the pop restoration result and the label information of the second sample audio is calculated to obtain a first time-domain loss value.

The calculation of the L1 loss between the pop restoration result and the label information of the second sample audio to obtain the first time-domain loss value in step b above may be represented as the following calculation formula (2):

$${L}_{T 1} ( s , \hat{s} ) = \frac{1}{N} {\sum }_{t = 1}^{N} \vert s ( t ) - \hat{s} ( t ) \vert \qquad ( 2 )$$

L_{T1}(s, ŝ) represents the first time-domain loss value, s(t) represents an audio signal corresponding to a t-th audio frame of the label information of the second sample audio, ŝ(t) represents an audio signal corresponding to a t-th audio frame of the pop restoration result, and N represents the number of audio frames in the second sample audio.

Step c: A mean squared error loss is calculated between the pop restoration result and the label information of the second sample audio at a plurality of resolutions to obtain a first frequency-domain loss value.

In some embodiments, the mean squared error loss between the pop restoration result and the label information of the second sample audio at resolutions of 256, 512, 1024, 2048, and 4096 may be calculated to obtain the first frequency-domain loss value.

The calculation of the mean squared error loss between the pop restoration result and the label information of the second sample audio at resolutions of 256, 512, 1024, 2048, and 4096 to obtain the first frequency-domain loss value may be represented as the following calculation formula (3):

$${L}_{F 1} ( s , \hat{s} ) = {\sum }_{256 , 512 , 1024 , 2048 , 4096} {MSE}_{fft} ( s ( t ) , \hat{s} ( t ) ) \qquad ( 3 )$$

L_{F1}(s, ŝ) represents the first frequency-domain loss value, MSE_{fft}(s(t),ŝ(t)) represents a mean squared error of spectrum features at fft points, and a calculation formula is shown as the following formula (4):

$${MSE}_{fft} ( s ( t ) , \hat{s} ( t ) ) = 0 \text{.5} * MSE ( \vert {S}_{C} \vert , \vert {\hat{s}}_{c} \vert ) + 0.5 * MSE ( {S}_{C} , {\hat{s}}_{c} ) \qquad ( 4 )$$

S_{C} represents an amplitude-compressed spectrum corresponding to the label information, and ŝ_{c} represents an amplitude-compressed spectrum corresponding to the pop restoration result. Calculation formulas of S_{C} and ŝ_{c} are shown as formulas (5) and (6) below:

$${S}_{c} = \frac{S}{\vert S \vert} {\vert S \vert}^{c} \qquad ( 10 )$$

$${\hat{S}}_{c} = \frac{\hat{S}}{\vert \hat{S} \vert} {\vert \hat{S} \vert}^{c} \qquad ( 11 )$$

c is a constant. For example, c=0.5.

Step d: The first time-domain loss value and the first frequency-domain loss value is fused to obtain a second fused loss value.

In some embodiments, the first time-domain loss value and the first frequency-domain loss value are fused to obtain the second fused loss value, includes performing a weighted summation on the first time-domain loss value and the first frequency-domain loss value to obtain the second fused loss value.

The weighted summation of the first time-domain loss value and the first frequency-domain loss value to obtain the second fused loss value may be represented as the following calculation formula (7):

$$L 2 = {L}_{T 1} ( s , \hat{s} ) * λ + {L}_{F 1} ( s , \hat{s} ) * ( 1 - λ ) \qquad ( 7 )$$

L2 represents the second fused loss value, L_{T1}(s, ŝ) represents the first time-domain loss value, L_{F1}(s, ŝ) represents the first frequency-domain loss value, and λ is a constant.

Step e: Parameters of the pop restoration model are adjusted based on the second fused loss value.

For a method for generating the sample data for training the pop restoration model, reference may be made to the method for generating the sample data for training the pop detection model. To avoid repetition, repeated descriptions are omitted herein.

S304: Speech detection is performed on the first audio based on a speech detection model to obtain a speech proportion of the first audio.

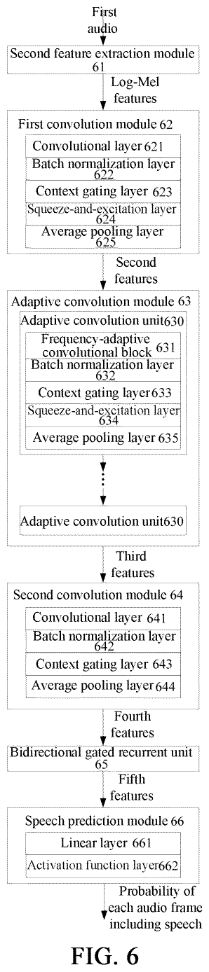

Referring to FIG. 6, the speech detection model includes: a second feature extraction module 61, a first convolution module 62, an adaptive convolution module 63, a second convolution module 64, a bidirectional gated recurrent unit (Bi-GRU) 65, and a speech prediction module 66.

The second feature extraction module 61 is configured to extract log-Mel features of the audio to be restored.

The log-Mel features are a feature representation method commonly used in the field of audio processing and speech recognition, and Mel frequency cepstral coefficients (MFCC) and logarithmic operations are combined to effectively capture spectrum features of the audio signal.

The first convolution module 62 is configured to process the log-Mel features to obtain second features. The first convolution module 62 comprises a convolutional layer 621, a batch normalization layer (BN) 622, a context gating layer (CG) 623, a squeeze-and-excitation layer 624, and an average pooling layer, which are sequentially connected in series.

The adaptive convolution module 63 is configured to process the second features to obtain the third features. The adaptive convolution module 63 comprises a plurality of cascaded adaptive convolution units 630. Each adaptive convolution unit comprises a frequency-adaptive convolutional block 631, a batch normalization layer 632, a context gating layer 633, a squeeze-and-excitation layer 634, and an average pooling layer 635 which are sequentially connected in series.

In some embodiments, the adaptive convolution module 63 comprises four cascaded adaptive convolution units 630.

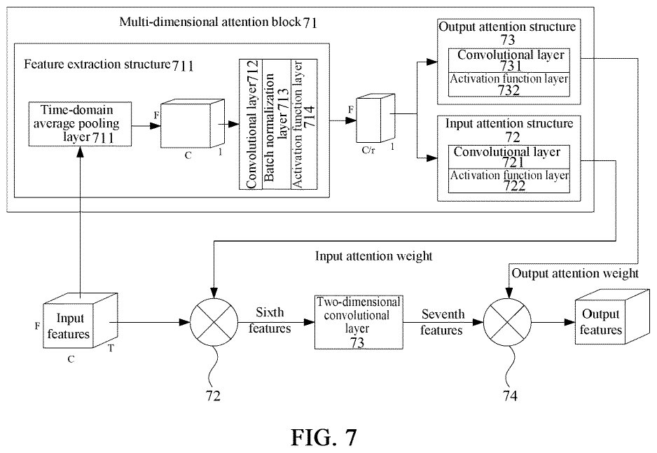

Referring to FIG. 7, the frequency-adaptive convolutional block 631 includes: a multi-dimensional attention block 71, a first multiplier 72, a two-dimensional convolutional layer 73, and a second multiplier 74.

The multi-dimensional attention block 71 is used to obtain an input attention weight and an output attention weight according to input features of the frequency-adaptive convolutional block. The multi-dimensional attention block 71 includes: a feature extraction structure 711, an input attention structure 712, and an output attention structure 713. The feature extraction structure 711 comprises a time-domain average pooling layer 711, a convolutional layer 712, a batch normalization layer 713, and an activation function layer 714 which are sequentially connected in series. The input attention structure 712 comprises a convolutional layer 721 and an activation function layer 722 which are sequentially connected in sequence. The output attention structure 713 comprises a convolutional layer 731 and an activation function layer 732, which are sequentially connected in sequence.

The first multiplier 72 is used to calculate the product of the input features of the frequency-adaptive convolutional block and the input attention weight to obtain sixth features.

The two-dimensional convolutional layer 73 is used to perform a convolution operation on the sixth features to obtain seventh features.

The second multiplier 74 is used to calculate the product of the seventh feature and the output attention weight to obtain the output features of the frequency-adaptive convolutional block.

The second convolution module 64 is configured to process the third features to obtain the fourth features. The second convolution module 64 comprises a convolutional layer 641, a batch normalization layer 642, a context gating layer 643, and an average pooling layer 644, which are sequentially connected in series.

The bidirectional gated recurrent unit 65 is used to process the fourth features to obtain fifth features.

The speech prediction module 66 is configured to process the fifth features to obtain a probability that each audio frame of the audio to be restored includes speech. The speech prediction module 66 comprises a linear layer 661 and an activation function layer 662, which are sequentially connected in series.

In some embodiments, before performing the speech detection on the audio to be restored based on the speech detection model, the method further includes: obtaining a first teacher model and a second teacher model, and performing knowledge distillation on the speech detection model based on the first teacher model and the second teacher model.

The first teacher model has a larger number of parameters than the speech detection model, and the second teacher model is a model obtained by training a bidirectional encoder representation from audio transformers (BEATs) model.

That is, a multi-teacher strategy is adopted to train the speech detection model. The plurality of teacher models includes: a pre-trained similar-type model with a large number of parameters and a teacher model obtained by fine-tuning on a specific dataset using the pre-trained BEATs model.

In some embodiments, performing the knowledge distillation on the speech detection model based on the first teacher model and the second teacher model includes the following steps 1 to 8:

Step 1: The first sample audio is input into the speech detection model, and a first speech separation result output by the speech detection model is obtained, and first intermediate features output by the second convolution module of the speech detection model is obtained.

Step 2: The first sample audio is input into the first teacher model, and obtain a second speech separation result output by the first teacher model.

Step 3: The first sample audio is input into the second teacher model, and obtain second intermediate features output by a target intermediate layer of the second teacher model is obtained, where the target intermediate layer is a layer structure in the second teacher model corresponding to the second convolution module.

Step 4: A binary cross-entropy loss is calculated between the first speech separation result and label information of the first sample audio to obtain a first loss value.

The calculation of the binary cross-entropy loss between the first speech separation result and label information of the first sample audio to obtain the first loss value in step 4 above may be represented as the following calculation formula (8):

$${L}_{BSE} = - ( y log ( {\hat{y}}_{s t u} ) ) + ( 1 - y ) log ( 1 - {\hat{y}}_{s t u} ) \qquad ( 8 )$$

L_{BSE} represents the first loss value, y represents the label information of the first sample audio, and ŷₛₜᵤ represents the first speech separation result.

Step 5: A similarity loss is calculated between the first speech separation result and the second speech separation result to obtain a second loss value.

The calculation of the similarity loss between the first speech separation result and the second speech separation result to obtain the second loss value in step 5 above may be represented as the following calculation formula (9):

$${L}_{tch 1} = \frac{1}{N} \sum {( {\hat{y}}_{s t u} - {\hat{y}}_{tch 1} )}^{2} \qquad ( 9 )$$

L_{tch1} represents the second loss value, ŷₛₜᵤ represents the first speech separation result, and ŷ_{tch1} represents the second speech separation result.

Step 6: A similarity loss is calculated between the first intermediate features and the second intermediate features to obtain a third loss value.

The calculation of the similarity loss between the first intermediate features and the second intermediate features to obtain the third loss value in step 6 above may be represented as the following calculation formula (10):

$${L}_{tch 2} = \frac{1}{N} \sum {( {\hat{W}}_{s t u} - {\hat{W}}_{tch 2} )}^{2} \qquad ( 10 )$$

L_{tch2} represents the third loss value, Ŵₛₜᵤ represents the first intermediate features, and Ŵ_{tch2} represents the second intermediate features.

Step 7: The first loss value, the second loss value, and the third loss value are fused to obtain a first fused loss value.

In some embodiments, fusing the first loss value, the second loss value, and the third loss value to obtain the first fused loss value includes: performing a weighted summation on the first loss value, the second loss value, and the third loss value to obtain the first fused loss value.

The weighted summation of the first loss value, the second loss value, and the third loss value to obtain the first fused loss value may be represented as the following calculation formula (11):

$$L 1 = {L}_{BSE} * w 1 + {L}_{tch 1} * w 2 + {L}_{tch 2} * w 3 \qquad ( 11 )$$

L1 represents the first fused loss value, L_{BSE}, L_{tch1}, and L_{tch2} respectively represent the first loss value, the second loss value, and the third loss value, and w1, w2, and w3 respectively represent a weight coefficient of the first loss value, a weight coefficient of the second loss value, and a weight coefficient of the third loss value.

Step 8: The parameters of the speech detection model is adjusted based on the first fused loss value.

In some embodiments, a method for generating the sample data for training the speech detection model may include:
obtaining a clear speech signal, a noise signal, and a music signal, and fusing the clear speech signal, the noise signal, and the music signal to obtain the sample data for training the speech detection model.

The clear speech signal is represented by s(t), the noise signal is represented by n(t), the music signal is represented by m(t), and the method for generating the sample data for training the speech detection model may be represented as the following calculation formula (12):

$$x ( t ) = s ( t ) * {w}_{1} + n ( t ) * {w}_{2} + m ( t ) * {w}_{3} \qquad ( 12 )$$

x(t) represents the sample data for training the speech detection model, and w₁, w₂, and w₃ respectively, represent a weight of the clear speech signal, a weight of the noise signal, and a weight of the music signal. When a certain weight is 0, it indicates that a corresponding signal is absent from the sample data.

S305: The speech proportion is determined whether greater than a second threshold.

If the speech proportion is greater than the second threshold in step S305 above, the following step S306 is performed:

S306: Speech separation is performed on the first audio based on a speech separation model to obtain the second audio.

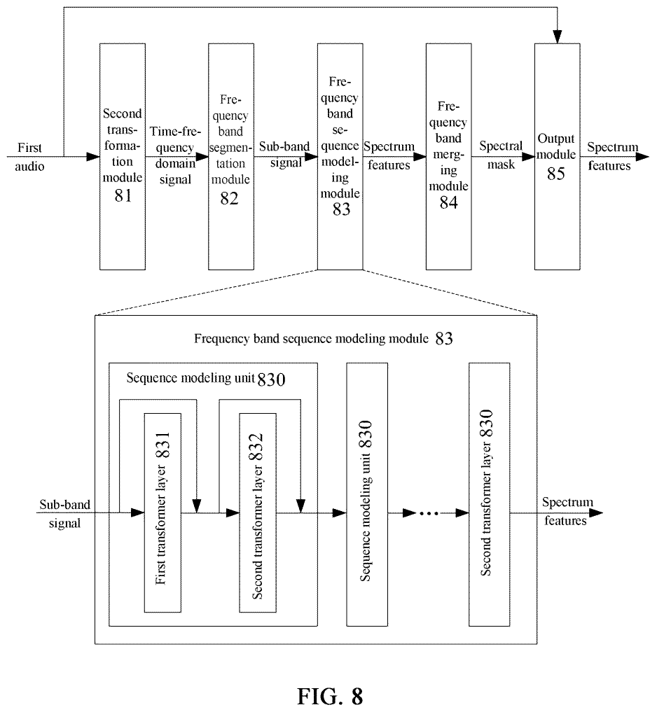

Referring to FIG. 8, the speech separation model includes: a second transformation module 81, a frequency band segmentation module 82, a frequency band sequence modeling module 83, a frequency band merging module 84, and an output module 85.

The second transformation module 81 is configured to perform the short-time Fourier transform on the first audio to obtain the first time-frequency domain signal.

The frequency band segmentation module 82 is configured to perform frequency band segmentation on the first time-frequency domain signal to segment

In some embodiments, the frequency band segmentation module includes: a segmentation unit and a selection unit. The segmentation unit is used to segment the first time-frequency domain signal into a second number of sub-band signals with non-overlapping frequency bands, and the selection unit is used to determine an effective frequency band of the audio to be restored according to a resolution of the audio to be restored, determine a first number according to the effective frequency band, and select the first number of sub-band signals from the second number of sub-band signals to segment the first time-frequency domain signal into the first number of sub-band signals with non-overlapping frequency bands, where the second number is greater than or equal to the first number.

Since a spectral range of audio varies with different sampling rates, the number of sub-band signals obtained through frequency band segmentation is selected according to the sampling rate before inputting a spectrum of the audio to be restored into the frequency band segmentation module.

For example, audio with a resolution of 48 KHz is segmented into K sub-band signals. When the sampling rate of the audio is lower than 48 KHz, the audio with the resolution of 48 KHz is first segmented into the K sub-band signals, and then L sub-band signals are selected from a low frequency to a high frequency, where L<K.

For another example, the audio with the resolution of 48 KHz is segmented into the K sub-band signals. When the sampling rate of the first audio is 24 kHz, the audio with the resolution of 48 KHz is first segmented into the K sub-band signals, and then K/2 sub-band signals are selected from the low frequency to the high frequency

The frequency band sequence modeling module 83 is configured to process the plurality of sub-band signals to obtain spectrum features of the plurality of sub-band signals. The frequency band sequence modeling module 83 comprises a plurality of sequence modeling units 830 connected in series, and each sequence modeling unit comprises two cascaded transformer layers (a first transformer layer 831 and a second transformer layer 832).

In some embodiments, the frequency band sequence modeling module 83 comprises eight sequence modeling units 830 connected in series. The two cascaded transformer layers process inter-band and temporal dependencies of the features respectively; to obtain spectrum features of the plurality of sub-band signals.

The frequency band merging module 84 is configured to merge the spectrum features of the plurality of sub-band signals to obtain a spectral mask of the first audio.

In some embodiments, the frequency band merging module 84 includes: K merging units, where each merging unit comprises a batch normalization layer and a fully connected layer.

The output module 85 is configured to calculate a product of the spectral mask and the first audio to obtain the second audio.

In some embodiments, before performing the speech separation on the first audio based on the speech separation model to obtain the second audio, the audio restoration method according to this embodiment of this application further includes: training the speech separation model. An implementation for training the speech separation model includes the following steps I to V:

Step I: The third sample audio is input into the speech separation model and a speech separation result of the third sample audio output by the speech separation model is obtained.

Step II: An L1 loss is calculated between the speech separation result and label information of the third sample audio to obtain a second time-domain loss value.

The calculation of the L1 loss between the speech separation result and label information of the third sample audio to obtain the second time-domain loss value in step II above may be represented as the following calculation formula (13):

$${L}_{T 2} ( s , \hat{s} ) = \frac{1}{N} {\sum }_{t = 1}^{N} \vert s ( t ) - \hat{s} ( t ) \vert \qquad ( 13 )$$

L_{T2}(s, ŝ) represents the first time-domain loss value, s(t) represents an audio signal corresponding to a t-th audio frame of the label information of the third sample audio, ŝ(t) represents an audio signal corresponding to a t-th audio frame of the speech separation result, and N represents the number of audio frames in the third sample audio.

Step III: A mean squared error loss is calculated between the speech separation result and the label information of the third sample audio at a plurality of resolutions to obtain a second frequency-domain loss value.

In some embodiments, the mean squared error loss between the speech separation result and the label information of the third sample audio at resolutions of 256, 512, 1024, 2048, and 4096 may be calculated to obtain the second frequency-domain loss value.

The calculation of the mean squared error loss between the speech separation result and the label information of the second sample audio at the resolutions of 256, 512, 1024, 2048, and 4096 to obtain the second frequency-domain loss value may be represented as the following calculation formula (14):

$${L}_{F 2} ( s , \hat{s} ) = {\sum }_{256 , 512 , 1024 , 2048 , 4096} {MSE}_{fft} ( s ( t ) , \hat{s} ( t ) ) \qquad ( 14 )$$

L_{F2}(s, ŝ) represents the second frequency-domain loss value, and MSE_{fft}(s(t),ŝ(t)) represents a mean squared error of spectrum features at fft points.

For a method for generating the sample data for training the speech separation model, reference may be made to the method for generating the sample data for training the speech separation model. To avoid repetition, repeated descriptions are omitted herein.

Step IV: The second time-domain loss value and the second frequency-domain loss value are fused to obtain a third fused loss value.

In some embodiments, the second time-domain loss value and the second frequency-domain loss value are fused to obtain the third fused loss value includes: performing a weighted summation on the second time-domain loss value and the second frequency-domain loss value to obtain the third fused loss value.

The weighted summation of the second time-domain loss value and the second frequency-domain loss value to obtain the third fused loss value may be represented as the following calculation formula (15):

$$L 3 = {L}_{T 2} ( s , \hat{s} ) * γ + {L}_{F 1} ( s , \hat{s} ) * ( 1 - γ ) \qquad ( 15 )$$

L3 represents the second fused loss value, L_{T2}(s, ŝ) represents the second time-domain loss value, L_{F2}(s, ŝ) represents the second frequency-domain loss value, and y is a constant.

Step V: Parameters of the speech separation model are adjusted based on the third fused loss value.

In some embodiments, the method for generating the sample data for training the speech separation model includes: obtaining a clear speech signal, a noise signal, and a music signal, and mixing the clear speech signal, the noise signal, and the music signal according to a room impulse response function to obtain the sample data for training the speech separation model.

Mixing the clear speech signal, the noise signal, and the music signal according to the room impulse response function may be represented by the following calculation formula (16):

$$x ( t ) = s ( t ) * h ( t ) + n ( t ) + m ( t ) \qquad ( 16 )$$

x(t) represents the sample data for training the speech separation model, a label represents the clear speech signal s(t), h(t) represents the room impulse response function, n(t) represents the noise signal, and m(t) represents the music signal.

S307: Audio quality restoration is performed on the second audio based on an audio quality restoration model to obtain a restoration result of the audio to be restored.

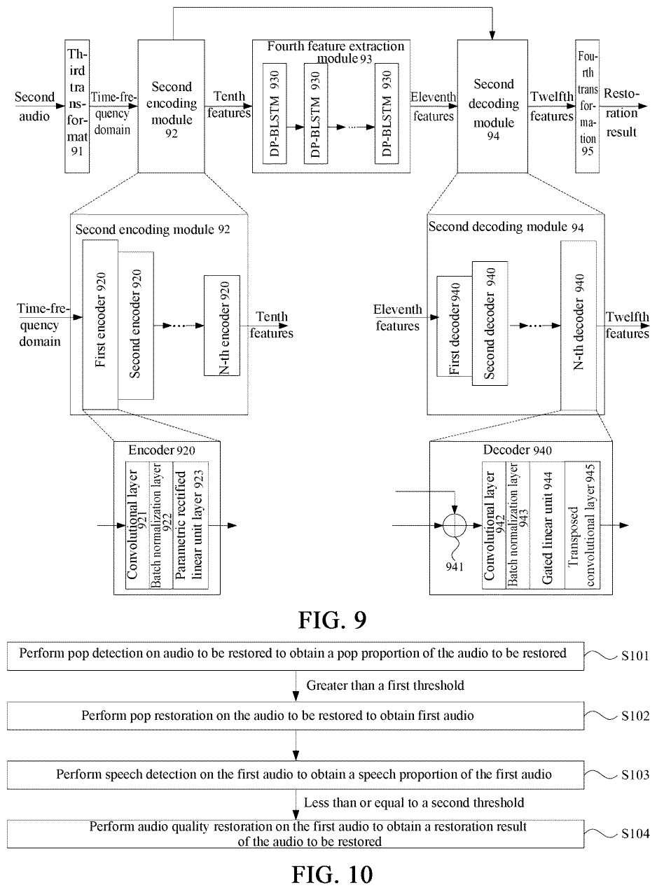

Referring to FIG. 9, the audio quality restoration model includes: a third transformation module 91, a second encoding module 92, a fourth feature extraction module 93, a second decoding module 94, and a fourth transformation module 95.

The third transformation module 91 is configured to perform the short-time Fourier transform on the second audio to obtain a third time-frequency domain signal.

The second encoding module 92 is configured to process the third time-frequency domain signal to obtain tenth features. The encoding module 92 includes N cascaded encoders 920, and each encoder 920 comprises a convolutional layer 921, a batch normalization layer 922, and a parametric rectified linear unit layer 923 which are sequentially connected in series.

In some embodiments, N=6. That is, the encoding module 92 comprises six cascaded encoders 920. The convolutional layers 921 of the six encoders 920 are all two-dimensional convolutional layers. Convolution kernel sizes are sequentially 5*8, 5*8, 5*8, 5*4, 5*4, and 5*4, strides are sequentially (1, 2), (1, 2), (1, 2), (1, 2), (1, 2), and (1, 2), and the number of output channels is sequentially 64, 128, 256, 512, 1024, and 1024.

The fourth feature extraction module 93 is configured to process the tenth features to obtain eleventh features. The fourth feature extraction module 93 comprises a plurality of deep bidirectional long short-term memory (DP-BLSTM) networks 930 which are connected in series.

In some embodiments, the fourth feature extraction module 93 comprises three deep bidirectional long short-term memory networks which are connected in series.

The second decoding module 94 is configured to process the eleventh features to obtain twelfth features. The decoding module 94 includes N cascaded decoders 940. Each decoder 940 comprises a concatenation layer 941, a convolutional layer 942, a batch normalization layer 943, a gated linear unit 944, and a transposed convolutional layer 945 which are sequentially connected in series. The concatenation layer 941 of the j-th decoder is used to concatenate output features of the (j−1)-th decoder and output features of the (N−j+1)-th encoder, where N and j are positive integers and j≤N.

In some embodiments, N=6. That is, the encoding module 92 comprises six cascaded encoders 920. The convolutional layers 921 of the six encoders 920 are all two-dimensional convolutional layers. Convolution kernel sizes are sequentially 5*4, 5*4, 5*4, 5*8, 5*8, and 5*8, strides are sequentially (1, 2), (1, 2), (1, 2), (1, 2), (1, 2), and (1, 2), and the number of output channels is sequentially 1024, 1024, 512, 256, 128, and 64.

The fourth transformation module 95 is configured to perform an inverse short-time Fourier transform on the twelfth features to obtain a restoration result of the audio to be restored.

In some embodiments, before performing the audio quality restoration on the second audio based on the audio quality restoration model, the inverse method further includes training the audio quality restoration model. An implementation for training the audio quality restoration model may include the following steps \textcircled{1} to \textcircled{7}:

Step \textcircled{1}: Fourth sample audio is input into the audio quality restoration model and an audio quality restoration result of the fourth sample audio output by the audio quality restoration model is obtained.

Step \textcircled{2}: The audio quality restoration result is input into a frequency-domain discriminator and a first probability value output by the frequency-domain discriminator and a first frequency-domain hidden feature output by a hidden layer of the frequency-domain discriminator are obtained.

The first probability value is a probability predicted by the frequency-domain discriminator that the audio quality restoration result is label information corresponding to the fourth sample audio.

Step \textcircled{3}: the audio quality restoration result is input into a sub-band discriminator and a second probability value output by the sub-band discriminator and a second sub-band hidden feature of the hidden layer of the sub-band discriminator are obtained, where the second probability value is a probability predicted by the sub-band discriminator that the audio quality restoration result is the label information corresponding to the fourth sample audio.

Step \textcircled{4}: a mean squared error loss is calculated between the audio quality restoration result and the label information of the fourth sample audio at a plurality of resolutions to obtain a third frequency-domain loss value.

Calculating the mean squared error loss between the audio quality restoration result and the label information of the fourth sample audio at the plurality of resolutions includes: calculating a mean squared error loss between the audio quality restoration result and the label information of the fourth sample audio at resolutions of 256, 512, 1024, 2048, and 4096.

The calculation of the mean squared error loss between the audio quality restoration result and the label information of the fourth sample audio at the resolutions of 256, 512, 1024, 2048, and 4096 to obtain the third frequency-domain loss value may be represented as the following calculation formula (17):

$${L}_{F 3} ( s , \hat{s} ) = {\sum }_{256 , 512 , 1024 , 2048 , 4096} {MSE}_{fft} ( s ( t ) , \hat{s} ( t ) ) \qquad ( 17 )$$

L_{F3}(s, ŝ) represents the second frequency-domain loss value, and MSE_{fft}(s(t),ŝ(t)) represents a mean squared error of spectrum features at fft points.

Step \textcircled{5}: An adversarial generation loss value is obtained based on the first probability value, the second probability value, the first frequency-domain hidden feature, a second frequency-domain hidden feature, the second sub-band hidden feature, and a second sub-band hidden feature.

The second frequency-domain hidden feature and the second sub-band hidden feature are an output of the hidden layer of the frequency-domain discriminator and an output of the hidden layer of the sub-band discriminator respectively when the label information corresponding to the fourth sample audio is used as an input.

In some embodiments, an implementation of obtaining the adversarial generation loss value according to the first probability value, the second probability value, the first frequency-domain hidden feature, the second frequency-domain hidden feature, the second sub-band hidden feature, and the second sub-band hidden feature may be represented as the following calculation formula (18):

$${loss}_{g a n} = {( {D}_{f} ( \hat{s} ) - 1 )}^{2} + {( {D}_{s} ( \hat{s} ) - 1 )}^{2} + α * ( {loss}_{f e a t} ( s , \hat{s} ; {D}_{f} ) + {loss}_{feat} ( s , \hat{s} ; {D}_{s} ) ) \qquad ( 18 )$$

loss_{gan} represents the adversarial generation loss value, D_{f}(ŝ) represents the first probability value, Dₛ(ŝ) represents the second probability value, loss_{feat}(s,ŝ; D_{f}) represents the MSE loss between the first frequency-domain hidden feature and the second frequency-domain hidden feature, loss_{feat}(s,ŝ; Dₛ) represents the MSE loss between the second sub-band hidden feature and the second sub-band hidden feature, and a is a constant.

In some embodiments, α=2.

Step \textcircled{6}: The third frequency-domain loss value and the adversarial generation loss value are fused to obtain a fourth fused loss value.

In some embodiments, fusing the third frequency-domain loss value and the adversarial generation loss value to obtain the fourth fused loss value includes performing a weighted summation on the third frequency-domain loss value and the adversarial generation loss value to obtain the fourth fused loss value.

The weighted summation of the third frequency-domain loss value and the adversarial generation loss value to obtain the fourth fused loss value may be represented as the following calculation formula (19):

$$L 4 = {loss}_{g a n} + β * {L}_{F 3} ( s , \hat{s} ) \qquad ( 19 )$$

L4 represents the fourth fused loss value, loss_{gan} represents the adversarial generation loss value, and L_{F3}(s, ŝ) represents the third frequency-domain loss value.

Step \textcircled{7}: parameters of the audio quality restoration model are adjusted based on the fourth fused loss value.

In some embodiments, an implementation for sample data for training the audio quality restoration model includes: obtaining an audio signal and performing nonlinear distortion processing on the audio signal to obtain the sample data for training the audio quality restoration model.

Performing the nonlinear distortion processing on the audio signal may be represented as the following calculation formula (20):

$${S}^{′} ( t ) = Φ ( S ( t ) ) \qquad ( 20 )$$

S′(t) represents the sample data used to train the audio quality restoration model, S(t) represents a label of the sample data, and Φ ( ) may represent nonlinear distortion processing such as bandpass filtering, encoding-decoding distortion, and acquisition distortion.

An embodiment of this application provides another audio restoration method. Referring to FIG. 10, the audio restoration method includes the following steps:

S101: A pop detection is performed on audio to be restored to obtain a pop proportion of the audio to be restored.

If the pop proportion is greater than a first threshold in step S101 above, the following step S102 is performed:

S102: A pop restoration is performed on the audio to be restored to obtain first audio.

S103: A speech detection is performed on the first audio to obtain a speech proportion of the first audio.

If the speech proportion is less than or equal to a second threshold in step S103 above, the following step S104 is performed:

S104: An audio quality restoration is performed on the first audio to obtain a restoration result of the audio to be restored.

For an implementation of performing the pop detection on the audio to be restored to obtain the pop proportion of the audio to be restored, reference may be made to the implementation of step S301 above. For an implementation of performing the pop restoration on the audio to be restored to obtain the first audio, reference may be made to the implementation of step S303 above. For an implementation of performing the speech detection on the first audio to obtain the speech proportion of the first audio, reference may be made to the implementation of step S304 above. For an implementation of performing the audio quality restoration on the first audio to obtain the restoration result of the audio to be restored, reference may be made to the implementation of step S307 above. To avoid repetition, detailed descriptions are omitted herein.

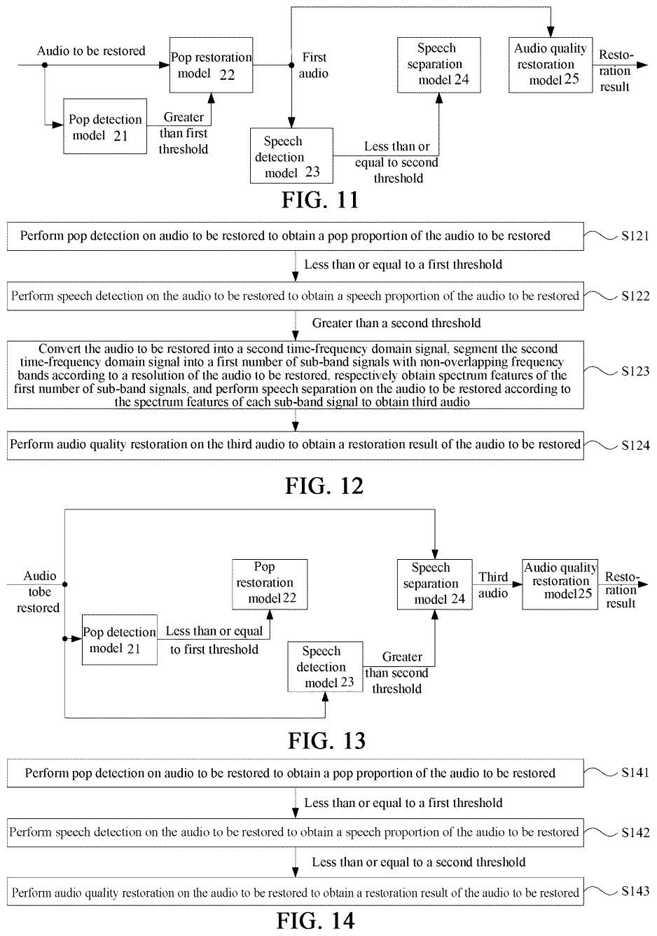

Referring to FIG. 11, when the above-mentioned embodiment is implemented based on an audio restoration system, the audio restoration system includes: a pop detection model 21, a pop restoration model 22, a speech detection model 23, a speech separation model 24, and an audio quality restoration model 25. The synchronization with the audio restoration system shown in FIG. 2 lies in that the speech separation model 24 does not work, and the audio quality restoration model 25 directly performs audio quality restoration on the first audio.

An embodiment of this application provides another audio restoration method. Referring to FIG. 12, the audio restoration method includes the following steps:

S121: A pop detection is performed on audio to be restored to obtain a pop proportion of the audio to be restored.

If the pop proportion is less than or equal to a first threshold in step S121 above, the following step S122 is performed:

S122: A speech detection is performed on the audio to be restored to obtain a speech proportion of the audio to be restored.

If the speech proportion is greater than a second threshold in step S122 above, the following step S123 is performed:

S123: The audio to be restored is converted into a second time-frequency domain signal, the second time-frequency domain signal is segmented into a first number of sub-band signals with non-overlapping frequency bands according to a resolution of the audio to be restored, respectively obtain spectrum features of the first number of sub-band signals, and a speech separation on the audio to be restored is performed based on the spectrum features of each sub-band signal to obtain third audio.

S124: An audio quality restoration is performed on the third audio to obtain a restoration result of the audio to be restored.

For an implementation of performing the pop detection on the audio to be restored to obtain the pop proportion of the audio to be restored, reference may be made to the implementation of step S301 above. For an implementation of performing the speech detection on the audio to be restored to obtain the speech proportion of the audio to be restored, reference may be made to the implementation of step S304 above. For an implementation of converting the audio to be restored into the second time-frequency domain signal, segmenting the second time-frequency domain signal into the first number of sub-band signals with the non-overlapping frequency bands according to the resolution of the audio to be restored, respectively obtaining the spectrum features of the first number of sub-band signals, and performing the speech separation on the audio to be restored according to the spectrum features of each sub-band signal to obtain the third audio, reference may be made to the implementation of step S306 above. For an implementation of performing the audio quality restoration on the third audio to obtain the restoration result of the audio to be restored, reference may be made to the implementation of step S307 above. To avoid repetition, detailed descriptions are omitted herein.

Referring to FIG. 13, when the above-mentioned embodiment is implemented based on an audio restoration system, the audio restoration system includes: a pop detection model 21, a pop restoration model 22, a speech detection model 23, a speech separation model 24, and an audio quality restoration model 25. The synchronization with the audio restoration system shown in FIG. 2 lies in that the pop restoration model 22 does not work, and the audio quality restoration model 25 directly restores the audio to be restored.

An embodiment of this application provides another audio restoration method. Referring to FIG. 14, the audio restoration method includes the following steps:

S141: A pop detection is performed on audio to be restored to obtain a pop proportion of the audio to be restored.

If the pop proportion is less than or equal to a first threshold in step S141 above, the following step S142 is performed:

S142: A speech detection is performed on the audio to be restored to obtain a speech proportion of the audio to be restored.

If the speech proportion is less than or equal to a second threshold in step S142 above, the following step S143 is performed:

S143: An audio quality restoration is performed on the audio to be restored to obtain a restoration result of the audio to be restored.

For an implementation of performing the pop detection on the audio to be restored to obtain the pop proportion of the audio to be restored, reference may be made to the implementation of step S301 above. For an implementation of performing the speech detection on the audio to be restored to obtain the speech proportion of the audio to be restored, reference may be made to the implementation of step S304 above. For an implementation of performing the audio quality restoration on the audio to be restored to obtain the restoration result of the audio to be restored, reference may be made to the implementation of step S307 above. To avoid repetition, detailed descriptions are omitted herein.

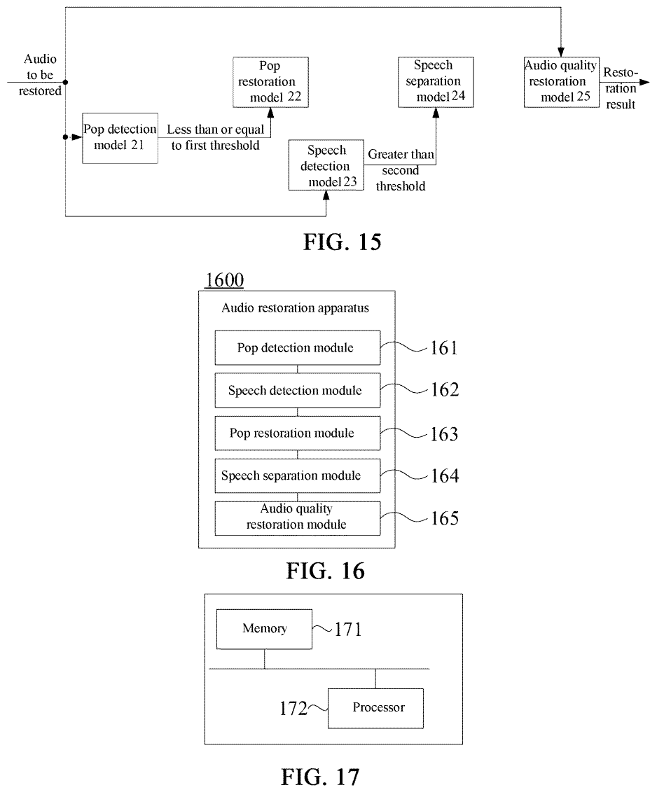

Referring to FIG. 15, when the above-mentioned embodiment is implemented based on an audio restoration system, the audio restoration system includes: a pop detection model 21, a pop restoration model 22, a speech detection model 23, a speech separation model 24, and an audio quality restoration model 25. The synchronization with the audio restoration system shown in FIG. 2 lies in that the speech separation model 24 and the pop restoration model 22 do not work, and the audio quality restoration model 25 directly restores the audio to be restored.

Based on the same inventive concept, as an implementation of the above-mentioned method, an embodiment of this application further provides an audio restoration apparatus. This embodiment corresponds to the above-mentioned method embodiment. For ease of reading, this embodiment does not reiterate the detailed content of the above-mentioned method embodiment step by step. However, it should be clarified that the audio restoration apparatus in this embodiment can correspondingly implement all the content in the above-mentioned method embodiment.

This embodiment of this application provides the audio restoration apparatus. FIG. 16 is a schematic structural diagram of the audio restoration apparatus. As shown in FIG. 16, the audio restoration apparatus 1600 includes:
a pop detection module 161, configured to perform pop detection on audio to be restored to obtain a pop proportion of the audio to be restored;
a pop restoration module 162, configured to perform pop restoration on the audio to be restored to obtain first audio in a case where the pop proportion is greater than a first threshold;
a speech detection module 163, configured to perform speech detection on the first audio to obtain a speech proportion of the first audio;
a speech separation module 164, configured to convert, in a case where the speech proportion is greater than a second threshold, the first audio into a first time-frequency domain signal, segment the first time-frequency domain signal into a first number of sub-band signals with non-overlapping frequency bands according to a resolution of the first audio, respectively obtain spectrum features of the first number of sub-band signals, and perform speech separation on the first audio according to the spectrum features of each sub-band signal to obtain second audio; and
an audio quality restoration module 165, configured to perform audio quality restoration on the second audio to obtain a restoration result of the audio to be restored.

As an optional implementation of this embodiment of this application, the pop detection module 161 is specifically configured to perform pop detection on the audio to be restored based on a pop detection model.

The pop detection model includes:
a first transformation module, configured to perform a short-time Fourier transform on the audio to be restored to obtain a second time-frequency domain signal;
a first feature extraction module, configured to perform feature extraction on the second time-frequency domain signal to obtain first features, where the first feature extraction module comprises a plurality of cascaded feature extraction units, and each feature extraction unit comprises a convolutional layer and a parametric rectified linear unit layer which are sequentially connected in series; and
a pop prediction module, configured to process the first features to obtain a probability of each audio frame in the audio to be restored being a pop, where the pop prediction module comprises a linear layer and an activation function layer which are sequentially connected in series.

As an optional implementation of this embodiment of this application, the speech detection module 163 is specifically configured to perform speech detection on the audio to be restored based on a speech detection model. The speech detection model includes:
a second feature extraction module, configured to extract log-Mel features of the audio to be restored;
a first convolution module, configured to process the log-Mel features to obtain second features, where the first convolution module comprises a convolutional layer, a batch normalization layer, a context gating layer, a squeeze-and-excitation layer, and an average pooling layer which are sequentially connected in series;
an adaptive convolution module, configured to process the second features to obtain third features, where the adaptive convolution module comprises a plurality of cascaded adaptive convolution units, and each adaptive convolution unit comprises a frequency-adaptive convolutional block, a batch normalization layer, a context gating layer, a squeeze-and-excitation layer, and an average pooling layer which are sequentially connected in series;
a second convolution module, configured to process the third features to obtain fourth features, where the second convolution module comprises a convolutional layer, a batch normalization layer, a context gating layer, and an average pooling layer which are sequentially connected in series;
a bidirectional gated recurrent unit, configured to process the fourth features to obtain fifth features; and
a speech prediction module, configured to process the fifth features to obtain a probability of each audio frame in the audio to be restored including a speech, where the speech prediction module comprises a linear layer and an activation function layer which are sequentially connected in series.

As an optional implementation of this embodiment of this application, the frequency-adaptive convolutional block includes:
a multi-dimensional attention block, used to obtain an input attention weight and an output attention weight according to input features of the frequency-adaptive convolutional block, where the multi-dimensional attention block includes a feature extraction structure, an input attention structure, and an output attention structure, the feature extraction structure comprises a time-domain average pooling layer, a convolutional layer, a batch normalization layer, and an activation function layer which are sequentially connected in series, and the input attention structure and the output attention structure are each composed of a convolutional layer and an activation function layer which are sequentially connected in sequence;
a first multiplier, used to calculate a product of the input features of the frequency-adaptive convolutional block and the input attention weight to obtain sixth features;
a two-dimensional convolutional layer, used to perform a convolution operation on the sixth features to obtain seventh features; and
a second multiplier, used to calculate a product of the seventh features and the output attention weight to obtain output features of the frequency-adaptive convolutional block.

As an optional implementation of this embodiment of this application, the speech detection module 163 is further configured to obtain a first teacher model and a second teacher model before performing the speech detection on the audio to be restored based on the speech detection model, where the first teacher model has a larger number of parameters than the speech detection model, and the second teacher model is a model obtained by training a bidirectional encoder representation from audio transformers model; and perform knowledge distillation on the speech detection model based on the first teacher model and the second teacher model.

As an optional implementation of this embodiment of this application, the speech detection module 163 is specifically configured to input first sample audio into the speech detection model, and obtain a first speech separation result output by the speech detection model, and first intermediate features output by the second convolution module of the speech detection model; input the first sample audio into the first teacher model, and obtain a second speech separation result output by the first teacher model; input the first sample audio into the second teacher model, and obtain second intermediate features output by a target intermediate layer of the second teacher model, where the target intermediate layer is a layer structure in the second teacher model corresponding to the second convolution module; calculate a binary cross-entropy loss between the first speech separation result and label information of the first sample audio to obtain a first loss value; calculate a similarity loss between the first speech separation result and the second speech separation result to obtain a second loss value; calculate a similarity loss between the first intermediate features and the second intermediate features to obtain a third loss value; fuse the first loss value, the second loss value, and the third loss value to obtain a first fused loss value; and adjust parameters of the speech detection model according to the first fused loss value.

As an optional implementation of this embodiment of this application, the pop restoration module 162 is specifically configured to perform, based on a pop restoration model, pop restoration on the audio to be restored to obtain first audio. The pop restoration model includes:
a first encoding module, configured to process the audio to be restored to obtain eighth features, where the first encoding module includes L cascaded encoders, and each encoder comprises a convolutional layer, a batch normalization layer, and a parametric rectified linear unit layer which are sequentially connected in series;
a third feature extraction module, configured to process the eighth features to obtain ninth features, where the third feature extraction module comprises a plurality of bidirectional long short-term memory networks which are connected in series; and
a first decoding module, configured to process the ninth features to obtain the first audio, where the first decoding module includes L cascaded decoders, each decoder comprises a concatenation layer, a convolutional layer, a batch normalization layer, a gated linear unit, and a transposed convolutional layer which are sequentially connected in series, the concatenation layer of the i-th decoder is used to concatenate output features of the (i−1)-th decoder and output features of the (L−i+1)-th encoder, L and i are positive integers, and i≤L.

As an optional implementation of this embodiment of this application, the pop restoration model 162 is further configured to input second sample audio into the pop restoration model and obtain a pop restoration result of the second sample audio output by the pop restoration model before performing the pop restoration on the audio to be restored based on the pop restoration model; calculate an L1 loss between the pop restoration result and label information of the second sample audio to obtain a first time-domain loss value; calculate a mean squared error loss between the pop restoration result and the label information of the second sample audio at a plurality of resolutions to obtain a first frequency-domain loss value; fuse the first time-domain loss value and the first frequency-domain loss value to obtain a second fused loss value; and adjust parameters of the pop restoration model according to the second fused loss value.

As an optional implementation of this embodiment of this application, the speech separation module 164 is specifically configured to convert the first audio into a first time-frequency domain signal based on a speech separation model, segment the first time-frequency domain signal into a first number of sub-band signals with non-overlapping frequency bands according to a resolution of the first audio, respectively obtain spectrum features of the sub-band signals, and perform speech separation on the first audio according to the spectrum features of each sub-band signal to obtain second audio. The speech separation model includes:
a second transformation module, configured to perform the short-time Fourier transform on the first audio to obtain the first time-frequency domain signal;
a frequency band segmentation module, including a segmentation unit and a selection unit, where the segmentation unit is used to segment the first time-frequency domain signal into a second number of sub-band signals with non-overlapping frequency bands, the selection unit is used to determine an effective frequency band of the audio to be restored according to a resolution of the audio to be restored, determine a first number according to the effective frequency band, and select the first number of sub-band signals from the second number of sub-band signals to segment the first time-frequency domain signal into the first number of sub-band signals with non-overlapping frequency bands, and the second number is greater than or equal to the first number;
a frequency band sequence modeling module, configured to respectively process the first number of sub-band signals to obtain spectrum features of the first number of sub-band signals, where the frequency band sequence modeling module comprises a plurality of sequence modeling units connected in series, and each sequence modeling unit comprises two cascaded transformer layers;
a frequency band merging module, configured to merge the spectrum features of the first number of sub-band signals to obtain a spectral mask of the first audio; and
an output module, configured to calculate a product of the spectral mask and the first audio to obtain the second audio.

As an optional implementation of this embodiment of this application, the speech separation module 164 is further configured to input third sample audio into the speech separation model and obtain a speech separation result of the third sample audio output by the speech separation model before performing the speech separation on the first audio based on the speech separation model; calculate an L1 loss between the speech separation result and label information of the third sample audio to obtain a second time-domain loss value; calculate a mean squared error loss between the speech separation result and the label information of the third sample audio at a plurality of resolutions to obtain a second frequency-domain loss value; fuse the second time-domain loss value and the second frequency-domain loss value to obtain a third fused loss value; and adjust parameters of the speech separation model according to the third fused loss value.

As an optional implementation of this embodiment of this application, the audio quality restoration module 165 is specifically configured to perform audio quality restoration on the second audio based on an audio quality restoration model to obtain a restoration result of the audio to be restored. The audio quality restoration model includes:
a third transformation module, configured to perform the short-time Fourier transform on the second audio to obtain a third time-frequency domain signal;
a second encoding module, configured to process the third time-frequency domain signal to obtain tenth features, where the encoding module includes N cascaded encoders, and each encoder comprises a convolutional layer, a batch normalization layer, and a parametric rectified linear unit layer which are sequentially connected in series;
a fourth feature extraction module, configured to process the tenth features to obtain eleventh features, where the fourth feature extraction module comprises a plurality of deep bidirectional long short-term memory networks which are connected in series;
a second decoding module, configured to process the eleventh features to obtain twelfth features, where the decoding module includes N cascaded decoders, each decoder comprises a concatenation layer, a convolutional layer, a batch normalization layer, a gated linear unit, and a transposed convolutional layer which are sequentially connected in series, the concatenation layer of the j-th decoder is used to concatenate output features of the (j−1)-th decoder and output features of the (N−j+1)-th encoder, N and j are positive integers, and j≤N; and
a fourth transformation module, configured to perform an inverse short-time Fourier transform on the twelfth features to obtain a restoration result of the audio to be restored.

As an optional implementation of this embodiment of this application, the audio quality restoration module 165 is further configured to input fourth sample audio into the audio quality restoration model and obtain an audio quality restoration result of the fourth sample audio output by the audio quality restoration model before performing the audio quality restoration on the second audio based on the audio quality restoration model; input the audio quality restoration result into a frequency-domain discriminator and obtain a first probability value output by the frequency-domain discriminator and a first frequency-domain hidden feature output by a hidden layer of the frequency-domain discriminator, where the first probability value is a probability predicted by the frequency-domain discriminator that the audio quality restoration result is label information corresponding to the fourth sample audio; input the audio quality restoration result into a sub-band discriminator and obtain a second probability value output by the sub-band discriminator and a second sub-band hidden feature of the hidden layer of the sub-band discriminator, where the second probability value is a probability predicted by the sub-band discriminator that the audio quality restoration result is the label information corresponding to the fourth sample audio; calculate a mean squared error loss between the audio quality restoration result and the label information of the fourth sample audio at a plurality of resolutions to obtain a third frequency-domain loss value; obtain an adversarial generation loss value according to the first probability value, the second probability value, the first frequency-domain hidden feature, a second frequency-domain hidden feature, the second sub-band hidden feature, and a second sub-band hidden feature, where the second frequency-domain hidden feature and the second sub-band hidden feature are an output of the hidden layer of the frequency-domain discriminator and an output of the hidden layer of the sub-band discriminator respectively when the label information corresponding to the fourth sample audio is used as an input; fuse the third frequency-domain loss value and the adversarial generation loss value to obtain a fourth fused loss value; and adjust parameters of the audio quality restoration model according to the fourth fused loss value.

As an optional implementation of this embodiment of this application,
the audio quality restoration module 165 is further configured to perform audio quality restoration on the first audio to obtain a restoration result of the audio to be restored in a case where the speech proportion is less than or equal to the second threshold.

As an optional implementation of this embodiment of this application,
the speech detection module 163 is further configured to perform speech detection on the audio to be restored to obtain a speech proportion of the audio to be restored in a case where the pop proportion is less than or equal to the first threshold;
the speech separation module 164 is further configured to convert, in a case where the speech proportion is greater than the second threshold, the audio to be restored into a second time-frequency domain signal, segment the second time-frequency domain signal into a first number of sub-band signals with non-overlapping frequency bands according to a resolution of the audio to be restored, respectively obtain spectrum features of the first number of sub-band signals, and perform speech separation on the audio to be restored according to the spectrum features of each sub-band signal to obtain third audio; and
the audio quality restoration module 165 is further configured to perform audio quality restoration on the third audio to obtain a restoration result of the audio to be restored.

As an optional implementation of this embodiment of this application,
the audio quality restoration module 165 is further configured to perform audio quality restoration on the audio to be restored to obtain a restoration result of the audio to be restored in a case where the speech proportion is less than or equal to the second threshold.

The audio restoration apparatus provided in this embodiment of this application may perform the audio restoration method according to any of the above-mentioned embodiments, sharing similar implementation principles and technical effects, which will not be detailed herein.

Based on the same inventive concept, an embodiment of this application further provides an electronic device. FIG. 17 is a schematic structural diagram of an electronic device according to an embodiment of this application. As shown in FIG. 17, the electronic device according to this embodiment includes a memory 171 and a processor 172. The memory 171 is configured to store a computer program, and the processor 172 is configured to execute the computer program to perform the audio restoration method according to the above-mentioned embodiment.

Based on the same inventive concept, an embodiment of this application further provides a computer-readable storage medium. The computer-readable storage medium has a computer program stored therein that, when executed by a processor, causes a computing device to implement the audio restoration method according to the above-mentioned embodiment.

Based on the same inventive concept, an embodiment of this application further provides a computer program product. The computer program product, when running on a computer, causes a computing device to implement the audio restoration method according to the above-mentioned embodiment.

Those skilled in the art should understand that the embodiments of this application may be provided as a method, a system, or a computer program product. Therefore, this application may adopt a form of a fully hardware-based embodiment, a fully software-based embodiment, or an embodiment that combines software and hardware aspects. In addition, this application may use a form of a computer program product implemented on one or more computer-usable storage media including computer-usable program code.

The processor may be a central processing unit (CPU), another general-purpose processor, a digital signal processor (DSP), an application specific integrated circuit (ASIC), a field-programmable gate array (FPGA), or other programmable logic devices, discrete gates or transistor logic devices, and discrete hardware components. The general-purpose processor may be a microprocessor, or any conventional processor, etc.

The memory may include a volatile memory, a random-access memory (RAM), and/or a nonvolatile internal memory, and other forms in a computer-readable medium, such as a read-only memory (ROM) or a flash RAM. The memory is an example of the computer-readable medium.

The computer-readable medium includes permanent and non-permanent, removable and non-removable storage media. The storage medium may store information by any method or technology. The information may be a computer-readable instruction, a data structure, a program module, or other data. Examples of the computer storage medium include, but are not limited to, a phase change memory (PRAM), a static random access memory (SRAM), a dynamic random access memory (DRAM), other types of random access memory (RAM), a read-only memory (ROM), an electrically erasable programmable read-only memory (EEPROM), a flash memory or other memory technologies, a compact disc read-only memory (CD-ROM), a digital versatile disc (DVD) or other optical storage, a magnetic cassette tape, a magnetic disk storage, or other magnetic storage devices, or any other non-transmission medium that may be configured to store information accessible to the computing device. According to the definition herein, the computer-readable medium docs not include transitory computer readable media, such as modulated data signals and carrier waves.

Finally, it should be noted that the above-mentioned embodiments are merely used for illustrating rather than limiting the technical solutions of this application; although this application has been described in detail with reference to the above-mentioned embodiments, those of ordinary skill in the art should understand that the technical solutions recorded in the above-mentioned various embodiments may still be modified, or some or all of the technical features may be equivalently substituted; and such modifications or substitutions do not make the essence of the corresponding technical solutions depart from the spirit and the scope of the technical solutions of the various embodiments of this application.

I/We claim:

1. An audio restoration method, comprising:
performing pop detection on audio to be restored to obtain a pop proportion of the audio to be restored;
performing pop restoration on the audio to be restored to obtain first audio in response to the pop proportion being greater than a first threshold;
performing speech detection on the first audio to obtain a speech proportion of the first audio;
converting, in responses to the speech proportion being greater than a second threshold, the first audio into a first time-frequency domain signal, segmenting the first time-frequency domain signal into a first number of sub-band signals with non-overlapping frequency bands based on a resolution of the first audio, respectively obtaining spectrum features of the first number of sub-band signals, and performing speech separation on the first audio based on the spectrum features of each sub-band signal to obtain second audio; and
performing audio quality restoration on the second audio to obtain a restoration result of the audio to be restored.

2. The method according to claim 1, wherein performing the pop detection on the audio to be restored comprises: performing the pop detection on the audio to be restored based on a pop detection model, and the pop detection model comprises:
a first transformation module, configured to perform a short-time Fourier transform on the audio to be restored to obtain a second time-frequency domain signal;
a first feature extraction module, configured to perform feature extraction on the second time-frequency domain signal to obtain first features, the first feature extraction module comprises a plurality of cascaded feature extraction units, and each feature extraction unit comprises a convolutional layer and a parametric rectified linear unit layer which are sequentially connected in series; and
a pop prediction module, configured to process the first features to obtain a probability of each audio frame in the audio to be restored being a pop, and the pop prediction module comprises a linear layer and an activation function layer which are sequentially connected in series.

3. The method according to claim 1, wherein performing the speech detection on the first audio comprises: performing the speech detection on the first audio based on a speech detection model, and the speech detection model comprises:
a second feature extraction module, configured to extract log-Mel features of the audio to be restored;
a first convolution module, configured to process the log-Mel features to obtain second features, wherein the first convolution module comprises a convolutional layer, a batch normalization layer, a context gating layer, a squeeze-and-excitation layer, and an average pooling layer which are sequentially connected in series;
an adaptive convolution module, configured to process the second features to obtain third features, wherein the adaptive convolution module comprises a plurality of cascaded adaptive convolution units, and the adaptive convolution unit comprises a frequency-adaptive convolutional block, a batch normalization layer, a context gating layer, a squeeze-and-excitation layer, and an average pooling layer which are sequentially connected in series;
a second convolution module, configured to process the third features to obtain fourth features, wherein the second convolution module comprises a convolutional layer, a batch normalization layer, a context gating layer, and an average pooling layer which are sequentially connected in series;
a bidirectional gated recurrent unit, configured to process the fourth features to obtain fifth features; and
a speech prediction module, configured to process the fifth features to obtain a probability of each audio frame in the audio to be restored comprising a speech, wherein the speech prediction module comprises a linear layer and an activation function layer which are sequentially connected in series.

4. The method according to claim 3, wherein the frequency-adaptive convolutional block comprises:
a multi-dimensional attention block, used to obtain an input attention weight and an output attention weight based on input features of the frequency-adaptive convolutional block, the multi-dimensional attention block comprises a feature extraction structure, an input attention structure, and an output attention structure, the feature extraction structure comprises a time-domain average pooling layer, a convolutional layer, a batch normalization layer, and an activation function layer which are sequentially connected in series, and the input attention structure and the output attention structure each comprises a convolutional layer and an activation function layer which are sequentially connected in sequence;
a first multiplier, used to calculate a product of the input features of the frequency-adaptive convolutional block and the input attention weight to obtain sixth features;
a two-dimensional convolutional layer, used to perform a convolution operation on the sixth features to obtain seventh features; and
a second multiplier, used to calculate a product of the seventh features and the output attention weight to obtain output features of the frequency-adaptive convolutional block.

5. The method according to claim 4, wherein before performing the speech detection on the audio to be restored based on the speech detection model, the method further comprises:
obtaining a first teacher model and a second teacher model, wherein the first teacher model has a larger number of parameters than the speech detection model, and the second teacher model is a model obtained by training a bidirectional encoder representation from audio transformers model; and
performing knowledge distillation on the speech detection model based on the first teacher model and the second teacher model.

6. The method according to claim 5, wherein performing the knowledge distillation on the speech detection model based on the first teacher model and the second teacher model comprises:
inputting first sample audio into the speech detection model, and obtaining a first speech separation result output by the speech detection model, and first intermediate features output by the second convolution module of the speech detection model;
inputting the first sample audio into the first teacher model, and obtaining a second speech separation result output by the first teacher model;
inputting the first sample audio into the second teacher model, and obtaining second intermediate features output by a target intermediate layer of the second teacher model, wherein the target intermediate layer is a layer structure in the second teacher model corresponding to the second convolution module;
calculating a binary cross-entropy loss between the first speech separation result and label information of the first sample audio to obtain a first loss value;
calculating a similarity loss between the first speech separation result and the second speech separation result to obtain a second loss value;
calculating a similarity loss between the first intermediate features and the second intermediate features to obtain a third loss value;
fusing the first loss value, the second loss value, and the third loss value to obtain a first fused loss value; and
adjusting parameters of the speech detection model based on the first fused loss value.

7. The method according to claim 1, wherein performing the pop restoration on the audio to be restored to obtain the first audio comprises: performing the pop restoration on the audio to be restored based on a pop restoration model to obtain the first audio, and the pop restoration model comprises:
a first encoding module, configured to process the audio to be restored to obtain eighth features, wherein the first encoding module comprises L cascaded encoders, and each encoder comprises a convolutional layer, a batch normalization layer, and a parametric rectified linear unit layer which are sequentially connected in series;
a third feature extraction module, configured to process the eighth features to obtain ninth features, wherein the third feature extraction module comprises a plurality of bidirectional long short-term memory networks which are connected in series; and
a first decoding module, configured to process the ninth features to obtain the first audio, wherein the first decoding module comprises L cascaded decoders, the decoder comprises a concatenation layer, a convolutional layer, a batch normalization layer, a gated linear unit, and a transposed convolutional layer which are sequentially connected in series, the concatenation layer of the i-th decoder is used to concatenate output features of the (i−1)-th decoder and output features of the (L−1+1)-th encoder, L and i are positive integers, and i≤L.

8. The method according to claim 7, wherein before performing the pop restoration on the audio to be restored based on the pop restoration model, the method further comprises:
inputting second sample audio into the pop restoration model and obtaining a pop restoration result of the second sample audio output by the pop restoration model;
calculating an L1 loss between the pop restoration result and label information of the second sample audio to obtain a first time-domain loss value;
calculating a mean squared error loss between the pop restoration result and the label information of the second sample audio at a plurality of resolutions to obtain a first frequency-domain loss value;
fusing the first time-domain loss value and the first frequency-domain loss value to obtain a second fused loss value; and
adjusting parameters of the pop restoration model according to the second fused loss value.

9. The method according to claim 1, wherein converting the first audio into the first time-frequency domain signal, segmenting the first time-frequency domain signal into the first number of sub-band signals with the non-overlapping frequency bands based on the resolution of the first audio, respectively obtaining the spectrum features of the sub-band signals, and performing the speech separation on the first audio based on the spectrum features of each sub-band signal to obtain the second audio comprises: converting the first audio into a first time-frequency domain signal based on a speech separation model, segmenting the first time-frequency domain signal into a first number of sub-band signals with non-overlapping frequency bands based on a resolution of the first audio, respectively obtaining spectrum features of the sub-band signals, and performing speech separation on the first audio based on the spectrum features of each sub-band signal to obtain second audio; and the speech separation model comprises:
a second transformation module, configured to perform a short-time Fourier transform on the first audio to obtain the first time-frequency domain signal;
a frequency band segmentation module, comprising a segmentation unit and a selection unit, wherein the segmentation unit is used to segment the first time-frequency domain signal into a second number of sub-band signals with non-overlapping frequency bands, the selection unit is used to determine an effective frequency band of the audio to be restored according to a resolution of the audio to be restored, determine a first number according to the effective frequency band, and select the first number of sub-band signals from the second number of sub-band signals to segment the first time-frequency domain signal into the first number of sub-band signals with non-overlapping frequency bands, and the second number is greater than or equal to the first number;
a frequency band sequence modeling module, configured to respectively process the first number of sub-band signals to obtain spectrum features of the first number of sub-band signals, wherein the frequency band sequence modeling module comprises a plurality of sequence modeling units connected in series, and each sequence modeling unit comprises two cascaded transformer layers;
a frequency band merging module, configured to merge the spectrum features of the first number of sub-band signals to obtain a spectral mask of the first audio; and
an output module, configured to calculate a product of the spectral mask and the first audio to obtain the second audio.

10. The method according to claim 9, wherein before performing the speech separation on the first audio based on the speech separation model, the method further comprises:
inputting third sample audio into the speech separation model and obtaining a speech separation result of the third sample audio output by the speech separation model;
calculating an L1 loss between the speech separation result and label information of the third sample audio to obtain a second time-domain loss value;
calculating a mean squared error loss between the speech separation result and the label information of the third sample audio at a plurality of resolutions to obtain a second frequency-domain loss value;
fusing the second time-domain loss value and the second frequency-domain loss value to obtain a third fused loss value; and
adjusting parameters of the speech separation model according to the third fused loss value.

11. The method according to claim 1, wherein performing the audio quality restoration on the second audio to obtain the restoration result of the audio to be restored comprises: performing audio quality restoration on the second audio based on an audio quality restoration model to obtain a restoration result of the audio to be restored, and the audio quality restoration model comprises:
a third transformation module, configured to perform a short-time Fourier transform on the second audio to obtain a third time-frequency domain signal;
a second encoding module, configured to process the third time-frequency domain signal to obtain tenth features, wherein the encoding module comprises N cascaded encoders, and each encoder comprises a convolutional layer, a batch normalization layer, and a parametric rectified linear unit layer which are sequentially connected in series;
a fourth feature extraction module, configured to process the tenth features to obtain eleventh features, wherein the fourth feature extraction module comprises a plurality of deep bidirectional long short-term memory networks which are connected in series;
a second decoding module, configured to process the eleventh features to obtain twelfth features, wherein the decoding module comprises N cascaded decoders, each decoder comprises a concatenation layer, a convolutional layer, a batch normalization layer, a gated linear unit, and a transposed convolutional layer which are sequentially connected in series, the concatenation layer of the j-th decoder is used to concatenate output features of the (j−1)-th decoder and output features of the (N−j+1)-th encoder, N and j are positive integers, and j≤N; and
a fourth transformation module, configured to perform an inverse short-time Fourier transform on the twelfth features to obtain a restoration result of the audio to be restored.

12. The method according to claim 1, wherein before performing the audio quality restoration on the second audio based on the audio quality restoration model, the method further comprises:
inputting fourth sample audio into the audio quality restoration model and obtaining an audio quality restoration result of the fourth sample audio output by the audio quality restoration model;
inputting the audio quality restoration result into a frequency-domain discriminator and obtaining a first probability value output by the frequency-domain discriminator and a first frequency-domain hidden feature output by a hidden layer of the frequency-domain discriminator, wherein the first probability value is a probability predicted by the frequency-domain discriminator that the audio quality restoration result is label information corresponding to the fourth sample audio;
inputting the audio quality restoration result into a sub-band discriminator and obtaining a second probability value output by the sub-band discriminator and a second sub-band hidden feature of a hidden layer of the sub-band discriminator, wherein the second probability value is a probability predicted by the sub-band discriminator that the audio quality restoration result is the label information corresponding to the fourth sample audio;
calculating a mean squared error loss between the audio quality restoration result and the label information of the fourth sample audio at a plurality of resolutions to obtain a third frequency-domain loss value;
obtaining an adversarial generation loss value according to the first probability value, the second probability value, the first frequency-domain hidden feature, a second frequency-domain hidden feature, the second sub-band hidden feature, and a second sub-band hidden feature, wherein the second frequency-domain hidden feature and the second sub-band hidden feature are an output of the hidden layer of the frequency-domain discriminator and an output of the hidden layer of the sub-band discriminator, respectively in response to the label information corresponding to the fourth sample audio being used as an input;
fusing the third frequency-domain loss value and the adversarial generation loss value to obtain a fourth fused loss value; and
adjusting parameters of the audio quality restoration model according to the fourth fused loss value.

13. The method according to claim 1, further comprising:
performing audio quality restoration on the first audio to obtain a restoration result of the audio to be restored in response to the speech proportion being less than or equal to the second threshold.

14. The method according to claim 1, further comprising:
performing speech detection on the audio to be restored to obtain a speech proportion of the audio to be restored in response to the pop proportion being less than or equal to the first threshold;
converting, in response to the speech proportion being greater than the second threshold, the audio to be restored into a second time-frequency domain signal, segmenting the second time-frequency domain signal into a first number of sub-band signals with non-overlapping frequency bands according to a resolution of the audio to be restored, respectively obtaining spectrum features of the first number of sub-band signals, and performing speech separation on the audio to be restored according to the spectrum features of each sub-band signal to obtain third audio; and
performing audio quality restoration on the third audio to obtain a restoration result of the audio to be restored.

15. The method according to claim 1, further comprising:
performing speech detection on the audio to be restored to obtain a speech proportion of the audio to be restored in response to the pop proportion being less than or equal to the first threshold;
performing audio quality restoration on the audio to be restored to obtain a restoration result of the audio to be restored in response to the speech proportion being less than or equal to the second threshold.

16. An electronic device, comprising one or more memories and one or more processors, wherein the one or more memories are configured to store instructions, and the one or more processors are configured to execute the instructions to cause the electronic device to:
perform pop detection on audio to be restored to obtain a pop proportion of the audio to be restored;
perform pop restoration on the audio to be restored to obtain first audio in response to the pop proportion being greater than a first threshold;
perform speech detection on the first audio to obtain a speech proportion of the first audio;
convert, in responses to the speech proportion being greater than a second threshold, the first audio into a first time-frequency domain signal, segmenting the first time-frequency domain signal into a first number of sub-band signals with non-overlapping frequency bands based on a resolution of the first audio, respectively obtaining spectrum features of the first number of sub-band signals, and performing speech separation on the first audio based on the spectrum features of each sub-band signal to obtain second audio; and
perform audio quality restoration on the second audio to obtain a restoration result of the audio to be restored.

17. The device according to claim 16, wherein the instructions causing the device to perform the pop detection on the audio to be restored comprise the instructions causing the device to perform the pop detection on the audio to be restored based on a pop detection model, and the pop detection model comprises:
a first transformation module, configured to perform a short-time Fourier transform on the audio to be restored to obtain a second time-frequency domain signal;
a first feature extraction module, configured to perform feature extraction on the second time-frequency domain signal to obtain first features, the first feature extraction module comprises a plurality of cascaded feature extraction units, and each feature extraction unit comprises a convolutional layer and a parametric rectified linear unit layer which are sequentially connected in series; and
a pop prediction module, configured to process the first features to obtain a probability of each audio frame in the audio to be restored being a pop, and the pop prediction module comprises a linear layer and an activation function layer which are sequentially connected in series.

18. The device according to claim 16, wherein the instructions causing the device to perform the speech detection on the first audio comprise the instructions causing the device to perform the speech detection on the first audio based on a speech detection model, and the speech detection model comprises:
a second feature extraction module, configured to extract log-Mel features of the audio to be restored;
a first convolution module, configured to process the log-Mel features to obtain second features, wherein the first convolution module comprises a convolutional layer, a batch normalization layer, a context gating layer, a squeeze-and-excitation layer, and an average pooling layer which are sequentially connected in series;
an adaptive convolution module, configured to process the second features to obtain third features, wherein the adaptive convolution module comprises a plurality of cascaded adaptive convolution units, and the adaptive convolution unit comprises a frequency-adaptive convolutional block, a batch normalization layer, a context gating layer, a squeeze-and-excitation layer, and an average pooling layer which are sequentially connected in series;
a second convolution module, configured to process the third features to obtain fourth features, wherein the second convolution module comprises a convolutional layer, a batch normalization layer, a context gating layer, and an average pooling layer which are sequentially connected in series;
a bidirectional gated recurrent unit, configured to process the fourth features to obtain fifth features; and
a speech prediction module, configured to process the fifth features to obtain a probability of each audio frame in the audio to be restored comprising a speech, wherein the speech prediction module comprises a linear layer and an activation function layer which are sequentially connected in series.

19. The device according to claim 18, wherein the frequency-adaptive convolutional block comprises:
a multi-dimensional attention block, used to obtain an input attention weight and an output attention weight based on input features of the frequency-adaptive convolutional block, the multi-dimensional attention block comprises a feature extraction structure, an input attention structure, and an output attention structure, the feature extraction structure comprises a time-domain average pooling layer, a convolutional layer, a batch normalization layer, and an activation function layer which are sequentially connected in series, and the input attention structure and the output attention structure each comprises a convolutional layer and an activation function layer which are sequentially connected in sequence;
a first multiplier, used to calculate a product of the input features of the frequency-adaptive convolutional block and the input attention weight to obtain sixth features;
a two-dimensional convolutional layer, used to perform a convolution operation on the sixth features to obtain seventh features; and
a second multiplier, used to calculate a product of the seventh features and the output attention weight to obtain output features of the frequency-adaptive convolutional block.

20. A non-transitory computer-readable storage medium, having a computer program stored therein that, when executed by a computing device, causes the computing device to:
perform pop detection on audio to be restored to obtain a pop proportion of the audio to be restored;
perform pop restoration on the audio to be restored to obtain first audio in response to the pop proportion being greater than a first threshold;
perform speech detection on the first audio to obtain a speech proportion of the first audio;
convert, in responses to the speech proportion being greater than a second threshold, the first audio into a first time-frequency domain signal, segmenting the first time-frequency domain signal into a first number of sub-band signals with non-overlapping frequency bands based on a resolution of the first audio, respectively obtaining spectrum features of the first number of sub-band signals, and performing speech separation on the first audio based on the spectrum features of each sub-band signal to obtain second audio; and
perform audio quality restoration on the second audio to obtain a restoration result of the audio to be restored.
